(19) United States
(12) Patent Application Publication
(10) Pub. No.: US 2026/0000564 A1
(43) Pub. Date: Jan. 1, 2026

(54) SYSTEMS FOR TREATING HAND, WRIST, AND FOREARM CONDITIONS

(71) Applicant: Anodyne Systems LLC, Madison, MS (US)

(72) Inventor: Joel Elisha Maier, Madison, MS (US)

(21) Appl. No.: 19/316,727

(22) Filed: Sep. 2, 2025

Related U.S. Application Data
(63) Continuation-in-part of application No. PCT/US2024/018210, filed on Mar. 1, 2024.
(60) Provisional application No. 63/488,600, filed on Mar. 6, 2023.
(60) Provisional application No. 63/582,166, filed on Sep. 12, 2023.
(60) Provisional application No. 63/693,672, filed on Sep. 11, 2024.

(51) Int. Cl. A61H 1/02

(52) U.S. Cl. CPC A61H 1/0285; A61H 1/0218; A61H 2201/0192; A61H 2201/1638; A61H 2201/169; A61H 2201/5002

(57) ABSTRACT

Devices and methods for treating hand, wrist, and forearm conditions. The device may include a resting portion for receiving a first side of a user's arm, and first and second contact portions configured to contact an opposite side of the user's arm at a first location and a second location respectively. The device can have a first configuration in which the first and second contact portions apply no force or minimal force to the user's arm and a second configuration in which the first contact portion is moved away from the first configuration in a first direction to apply a first force at the first location to stretch and compress tissue in the user's arm and the second contact portion is moved away from the first configuration in a second direction to apply a second force at the second location to stretch and compress tissue in the user's arm.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit of U.S. Provisional Application No. 63/693,672, filed Sep. 11, 2024. This application is a continuation-in-part of PCT Application No. US2024/018210, filed Mar. 1, 2024, which claims the benefit of U.S. Provisional Application No. 63/582,166, filed Sep. 12, 2023, and U.S. Provisional Application No. 63/488,600, filed Mar. 6, 2023. Each of the aforementioned applications are hereby incorporated by reference herein in their entireties.

### BACKGROUND

### Field

This application relates devices and methods for treating forearm, wrist, or hand conditions, such as carpal tunnel, Guyon's canal, and DeQuervain's syndromes.

### Description of the Related Art

Many people suffer from carpal tunnel, Guyon's canal, or DeQuervain's syndromes, which causes pain and loss of function in their hands. Surgical procedures for treating carpal tunnel, Guyon's canal, and DeQuervain's syndromes are expensive, invasive, and, as per all surgeries, risk serious complications. Non-surgical treatments for carpal tunnel syndrome usually involve splinting a patient's wrist with a cock-up splint that keeps the patient's wrist in neutral or slight extension. Other types of splints specific for Guyon's canal or DeQuervain's syndromes are commonly used in lieu of surgery. Splints do not work well because they do not directly address the myofascial restrictions present on the back of patient wrists. Non-surgical treatments also take a long time to recover from and are not always effective. The lack of effectiveness of non-surgical treatment (and possibly the perceived need to see no other option but for the election of surgery) stems from a lack of understanding about the etiology of carpal tunnel, Guyon's canal, and DeQuervain's syndromes, and so do not effectively address the underlying pathology.

### SUMMARY

There is a need for a medical device for treating forearm, wrist, or hand conditions, such as carpal tunnel, Guyon's canal, and/or DeQuervain's syndromes by releasing the myofascial restrictions that are the etiological causation for the underlying pathology. Manual release of myofascial restrictions is not always precise, strains the therapist's own hands, and may not produce the required amount of force needed to release said restrictions. The medical devices described herein release the myofascial restrictions by applying angled forces by contact portions to push into and spread the tissues on a side (e.g., a medial or a posterior side) of a person's wrist and forearm, whereby resulting in the release of myofascial restrictions, reducing symptoms of carpal tunnel syndrome. Likewise, the medical device also releases myofascial restrictions along the anatomical distributions of the muscles abductor policis longus and extensor policis brevis to relieve symptoms of DeQuervain's syndrome. The medical device can also relieve myofascial restrictions present in the tissues that constitute Guyon's canal. These devices remove the human element typically associated with myofascial release.

The medical devices described herein are capable of treating forearm, wrist, or hand conditions, such as carpal tunnel syndrome, Guyon's canal syndrome, and/or DeQuervain's syndrome. The medical devices can be used to stretch the tissue in a user's forearm, hand, and/or wrist. The medical devices generally include a resting portion for receiving a user's forearm, one or more contact portions configured to contact the user's forearm, and one or more actuators configured to control the movement of the contact portions relative to the resting portion. A first actuator can control one or more degrees of movement (e.g., rotation, tilt, translation, etc.) of a first contact portion and a second actuator can independently control one or more degrees of movement of the second contact portion. Though, in other embodiments, a single actuator may control one or more degrees of movement of both contact portions. A first actuator can control one degree of movement for both contact portions, and a second actuator can control another degree of movement for both contact portions. When the user's forearm is supported on the resting portion, the contact portions can be positioned above an opposite side of the user's forearm. The actuators can be used to move the contact portions towards the opposite side of the user's forearm to compress the user's forearm between the resting portion and the contact portions. The actuators can move the contact portions at angles relative to the resting portion. Accordingly, a first angular force can be applied to a first location on the user's forearm by the first contact portion and a second angular force can be applied to a second location on the user's forearm by the second contact portion. For example, the first actuator can apply a first force at a first variable pull angle and/or the second actuator can apply a second force at a second variable pull angle. Because the first and second forces are applied at angles relative to the resting portion, the first and second forces can both compress and stretch the user's tissue. For example, the first actuator can cause the first contact portion to apply both a first compressive force and a first stretching force to the user's arm at the first location. Similarly, the second actuator can cause the second contact portion to apply both a second compressive force and a second stretching force to the user's arm at the second location. The compressive forces may compress the user's tissue between the contact portions and the resting portions. The stretching forces may spread the user's tissue between the contact portions. Having individual actuators apply angular forces can provide a benefit of allowing a single actuator to apply both a compressive and a stretching force to the user's arm. For example, in other systems, a first actuator may be used to apply a first compressive force and a second actuator may be used to apply a first stretching force to a user's arm, increasing the complexity of the system. Conversely, in the medical devices described herein, a single actuator can apply both the first compressive force and the first stretching force, which can simplify the operation for the user. Applying an angled force to the user's arm may also increase the user's comfort during treatment.

In some implementations, the angles of the first force and/or the second force can be adjusted. For example, the first actuator can be configured to rotate relative to the resting portion, to change the angle of the first applied force. Similarly, the second actuator can be configured to rotate relative to the resting portion, to change the angle of the second applied force. Changing the angle of the applied forces may provide a benefit of allowing different treatments to be performed on the medical device. Changing the angle of the applied forces may also allow the medical device to be used by a larger number of user's with varying forearm dimensions.

In some implementations, the first actuator and/or the second actuator can be moveable relative to the resting portion. For example, the first actuator can be translated along the resting portion to change a distance between the first contact portion and the second contact portion. Similarly, the second actuator can be translated along the resting portion to change a distance between the first contact portion and the second contact portion. Changing the distance between the first contact portion and the second contact portion can also change the distance between the first location where the first force is applied and the second location where the second force is applied. Having actuators that can move relative to the resting portion may provide a benefit of allowing different treatments to be performed on the medical device. Changing the distance between the contact portions may also allow the medical device to be used by a larger number of user's with varying forearm dimensions.

In some implementations, the contact portions can be rotationally coupled to the actuators. For example, the first contact portion can be rotationally coupled to the first actuator and the second contact portion can be rotationally coupled to the second actuator. Rotatable contact portions may provide a benefit of allowing the user to properly align the contact portions with their arm during treatment. For example, when the user rests their forearm on the resting portion, the angle between their arm and the resting portion can vary along the length of their forearm. When applying forces via the contact portions, it can be desirable for the contact portions to lie flat on the first and second locations. For example, when the contact portions lie flat, a more even distribution of force at the first and second locations can be provided to the user. Accordingly, rotatable contact portions can provide a benefit of allowing the user to apply evenly distributed forces at the first and second locations, which can improve user comfort and/or improve the results of the treatment.

Any feature, structure, or step disclosed herein can be replaced with or combined with any other feature, structure, or step disclosed herein, or omitted. Further, for purposes of summarizing the disclosure, certain aspects, advantages, and features of the inventions have been described herein. It is to be understood that not necessarily any or all such advantages are achieved in accordance with any particular embodiment of the inventions disclosed herein. No individual aspects of this disclosure are essential or indispensable.

In some embodiments, a device can include: a resting portion for receiving a first side of a user's arm; a first contact portion configured to contact an opposite side of the user's arm at a first location; and a second contact portion configured to contact the opposite side of the user's arm at a second location; the device having a first configuration in which the first contact portion and the second contact portion apply no force or minimal force to the user's arm; the device having a second configuration in which the first contact portion is moved away from the first configuration in a first direction to apply a first force at the first location to stretch and compress tissue in the user's arm and the second contact portion is moved away from the first configuration in a second direction to apply a second force at the second location to stretch and compress tissue in the user's arm.

In some embodiments, an angle between the first direction and the second direction is acute. In some embodiments, an angle between the first direction and the second direction is oblique. In some embodiments, a first angle between the first direction and the resting portion is adjustable and a second angle between the second direction and the resting portion is adjustable. In some embodiments, the first angle is acute and the second angle is acute. In some embodiments, the first contact portion is configured to move independently of the second contact portion. In some embodiments, the device can further include: a first actuator coupled to the first contact portion and a second actuator coupled to the second contact portion, the first actuator configured to move the first contact portion between the first configuration and the second configuration, the second actuator configured to move the second contact portion between the first configuration and the second configuration. In some embodiments, a first distance between the first contact portion and the second contact portion in the first configuration is adjustable, wherein adjusting the first distance changes a second distance between the first location and the second location. In some embodiments, the first contact portion is rotatable relative to the first actuator and the second contact portion is rotatable relative to the second actuator. In some embodiments, the first contact portion is configured to move between a locked configuration and an unlocked configuration, wherein in the unlocked configuration the first contact portion is rotatable relative to the first actuator, wherein in the locked configuration, the first contact portion is rotationally fixed to the first actuator. In some embodiments, the second contact portion is configured to move between a locked configuration and an unlocked configuration, wherein in the unlocked configuration the second contact portion is rotatable relative to the second actuator, wherein in the locked configuration, the second contact portion is rotationally fixed to the second actuator. In some embodiments, the first actuator is configured to adjust the first force in the first direction applied by the first contact portion and the second actuator is configured to adjust the second force in the second direction applied by the second contact portion. In some embodiments, a first magnitude of the first force is independently controllable by the first actuator and a second magnitude of the second force is independently controllable by the second actuator. In some embodiments, the first actuator further includes a first release mechanism and the second actuator further includes a second release mechanism, the first release mechanism configured to release a position of the first contact portion, the second release mechanism configured to release a position of the second contact portion. In some embodiments, the first actuator includes a first clamp and the second actuator includes a second clamp. In some embodiments, the device further includes a first contact pad and a second contact pad, the first contact pad positioned between the first contact portion and the user's arm, the second contact pad positioned between the second contact portion and the user's arm. In some embodiments, the first contact pad and the second contact pad includes a compressible material. In some embodiments, first contact pad includes a first contact surface including an adhesive and the second contact pad includes a second contact surface including the adhesive, the adhesive configured to promote traction between the user's skin and the first contact pad and the second contact pad. In some embodiments, the resting portion further includes a top surface, the top surface configured to receive the first side of the user's arm. In some embodiments, the top surface is planar. In some embodiments, the top surface further includes a convex central stage. In some embodiments, the top surface further includes a concave central stage. In some embodiments, the first location is different than the second location. In some embodiments, the first actuator is configured to translate along the resting portion, wherein translation of the first actuator changes the first distance and the second distance. In some embodiments, the second actuator is configured to translate along the resting portion, wherein translation of the second actuator changes the first distance and the second distance.

In some embodiments, a device can include: a base including: a top portion for receiving a first side of a user's arm; and a bottom portion for supporting the device; a first contact portion configured to contact an opposite side of the user's arm; a second contact portion configured to contact the opposite side of the user's arm; a first actuator coupled to the base between the top portion and the bottom portion at a first end and coupled to the first contact portion at a second end; a second actuator coupled to the base between the top portion and the bottom portion at a third end and coupled to the second contact portion at a third end; the first actuator configured to move the first contact portion between a first configuration in which the first contact portion applies no force or minimal force to the user's arm and a second configuration in which the first contact portion applies a first force in a first direction to the user's arm at a first location; the second actuator configured to move the second contact portion between a first configuration in which the second contact portion applies no force or minimal force to the user's arm and a second configuration in which the second contact portion applies a second force in a second direction to the user's arm at a second location.

In some embodiments, an angle between the first direction and the second direction is acute. In some embodiments, an angle between the first direction and the second direction is oblique. In some embodiments, a first angle between the first direction and the top portion is adjustable and a second angle between the second direction and the top portion is adjustable. In some embodiments, the first angle is acute and the second angle is acute. In some embodiments, the first contact portion is configured to move independently of the second contact portion. In some embodiments, a first distance between the first contact portion and the second contact portion in the first configuration is adjustable, wherein adjusting the first distance changes a second distance between the first location and the second location. In some embodiments, the first contact portion is rotatable relative to the first actuator and the second contact portion is rotatable relative to the second actuator. In some embodiments, the first contact portion is configured to move between a locked configuration and an unlocked configuration, wherein in the unlocked configuration the first contact portion is rotatable relative to the first actuator, wherein in the locked configuration, the first contact portion is rotationally fixed to the first actuator. In some embodiments, the second contact portion is configured to move between a locked configuration and an unlocked configuration, wherein in the unlocked configuration the second contact portion is rotatable relative to the second actuator, wherein in the locked configuration, the second contact portion is rotationally fixed to the second actuator. In some embodiments, the first actuator is configured to adjust the first force in the first direction applied by the first contact portion and the second actuator is configured to adjust the second force in the second direction applied by the second contact portion. In some embodiments, a first magnitude of the first force is independently controllable by the first actuator and a second magnitude of the second force is independently controllable by the second actuator. In some embodiments, the first actuator further includes a first release mechanism and the second actuator further includes a second release mechanism, the first release mechanism configured to release a position of the first contact portion, the second release mechanism configured to release a position of the second contact portion. In some embodiments, the first actuator includes a first clamp and the second actuator includes a second clamp. In some embodiments, the device further includes: a first contact pad and a second contact pad, the first contact pad positioned between the first contact portion and the user's arm, the second contact pad positioned between the second contact portion and the user's arm.

In some embodiments, the first contact pad and the second contact pad includes a compressible material. In some embodiments, the first contact pad includes a first contact surface including an adhesive and the second contact pad includes a second contact surface including the adhesive, the adhesive configured to promote traction between the user's skin and the first contact pad and the second contact pad. In some embodiments, the top portion is planar. In some embodiments, the top portion further includes a convex central stage. In some embodiments, the top portion further includes a concave central stage. In some embodiments, the first location is different than the second location.

In some embodiments, a method for treating a user is disclosed. The method can include: positioning a first side of a user's arm on a resting portion of a device; contacting a first contact portion of the device with an opposite second side of the user's arm at a first location; contacting a second contact portion of the device with the second side of the user's arm at a second location; applying a first force in a first direction to the user's arm at the first location using the first contact portion to stretch and compress the user's arm at the first location; and applying a second force in a second direction to the user's arm at the second location using the second contact portion to stretch and compress the user's arm at the second location.

In some embodiments, the first contact portion is rotationally fixed relative to the resting portion when applying the first force and the second contact portion is rotationally fixed relative to the resting portion when applying the second force. In some embodiments, the method further includes: adjusting a first angle of the first direction relative to the resting portion. In some embodiments, the method further includes: adjusting a second angle of the second direction relative to the resting portion. In some embodiments, the first angle and the second angle are acute angles. In some embodiments, the method further includes: adjusting a distance between the first contact portion and the second contact portion. In some embodiments, a first actuator coupled to the first contact portion is rotated relative to the resting portion to adjust the first angle. In some embodiments, a first actuator coupled to the first contact portion is translated along the resting portion to adjust the distance between the first contact portion and the second contact portion. In some embodiments, a second actuator coupled to the second contact portion is rotated relative to the resting portion to adjust the second angle. In some embodiments, a second actuator coupled to the second contact portion is translated along the resting portion to adjust the distance between the first contact portion and the second contact portion. In some embodiments, the first side is an anterior side of the user's arm. In some embodiments, the first side is a medial side of the user's arm. In some embodiments, the first side is a lateral side of the user's arm. In some embodiments, the first location is above the metacarpal bones of the user's arm. In some embodiments, the first location is above the posterior side of the metacarpal bones. In some embodiments, the first location is above the lateral side of the metacarpal bones. In some embodiments, the second location is above the radius and ulna bones of the user's arm. In some embodiments, the second location is above the posterior sides of the radius and ulna bones of the user's arm. In some embodiments, the second location is above the lateral sides of the radius and ulna bones of the user's arm. In some embodiments, the first contact portion applies the first force independently of the second contact portion applying the second force. In some embodiments, the method further includes: rotating the first contact portion relative to the resting portion until the first contact portion lies flat on the first location. In some embodiments, the method further includes: rotating the second contact portion relative to the resting portion until the second contact portion lies flat on the second location. In some embodiments, an angle between the first direction and the second direction is oblique. In some embodiments, an angle between the first direction and the second direction is between 90 degrees and 180 degrees.

In some embodiments, a medical device can include: a base portion including: a bottom portion configured to support the medical device; and a top portion configured to support a user's forearm; and a first adjustable slot and a second adjustable slot, the first and second adjustable slots extending from a first side of the base portion to a second side of the base portion; and a first clamp and a second clamp, a first end of the first clamp and a first end of the second clamp removably coupled to a first rod, the first rod extending through the first adjustable slot; a first contact pad removably coupled to a second end of the first clamp and a second end of the second clamp, the first contact pad configured to contact the user's forearm at a first location, wherein the first clamp and the second clamp are configured to adjust a position of the first contact pad relative to the user's forearm; a third clamp and a fourth clamp, a first end of the third clamp and a first end of the fourth clamp removably coupled to a second rod, the second rod extending through the second adjustable slot; and a second contact pad removably coupled to a second end of the third clamp and a second end of the fourth clamp, the second contact pad configured to contact the user's forearm at a second location, wherein the third clamp and the fourth clamp are configured to adjust a position of the second contact pad relative to the user's forearm.

In some embodiments, the first clamp and the second clamp are configured to apply a first force to the user's forearm at the first location via the first contact pad, wherein the third clamp and the fourth clamp are configured to apply a second force to the user's forearm at the second location via the second contact pad. In some embodiments, the first adjustable slot and second adjustable slots include a plurality of ridges. In some embodiments, the first rod is configured to change positions within the first adjustable slot, wherein the second rod is configured to change positioned within the second adjustable slot. In some embodiments, changing the position of the first rod within the first adjustable slot adjust a first angle of the first contact pad relative to the base portion, wherein changing the position of the second rod within the second adjustable slot adjust a second angle of the second contact pad relative to the base portion. In some embodiments, the first contact pad is configured to move between a locked configuration and an unlocked configuration with the second ends of the first and second clamps, wherein the second contact pad is configured to move between a locked configuration and an unlocked configuration with the second ends of the third and fourth clamps. In some embodiments, in the unlocked configuration, the first contact pad can rotate relative to the second ends of the first and second clamps and in the locked configuration, a rotational position of the first contact pad relative to the second ends of the first and second clamps is fixed, wherein in the unlocked configuration, the second contact pad can rotate relative to the second ends of the third and fourth clamps and in the locked configuration, a rotational position of the second contact pad relative to the second ends of the third and fourth clamps is fixed. In some embodiments, the second end of the first clamp includes a first adaptor, the second end of the second clamp includes a second adaptor, the second end of the third clamp includes a third adaptor, and the second end of the fourth clamp includes a fourth adaptor. In some embodiments, the first, second, third, and fourth adaptors each include a plurality of adaptor teeth and a plurality of adaptor ridges, wherein the first contact pad includes a plurality of first contact teeth and the second contact pad includes a plurality of second contact teeth, wherein the plurality of adaptor ridges of the first, second, third, and fourth adaptors are configured to receive the plurality of first contact teeth of the first contact pad and/or the plurality of second contact teeth of the second contact pad.

In some embodiments, a medical device can include: a base portion including: a bottom portion configured to support the medical device; and a top portion configured to support a user's forearm; and a first adjustable slot and a second adjustable slot, the first and second adjustable slots extending from a first side of the base portion to a second side of the base portion; and a first clamp, a first end of the first clamp configured to receive a first end of a first rod, the first rod extending through the first adjustable slot; a first contact pad removably coupled to a second end of the first clamp, the first contact pad configured to contact the user's forearm at a first location, wherein the first clamp is configured to adjust a position of the first contact pad relative to the user's forearm; a second clamp, a first end of the second clamp configured to receive a first end of a second rod, the second rod extending through the second adjustable slot; a second contact pad removably coupled to a second end of the second clamp, the second contact pad configured to contact the user's forearm at a second location, wherein the second clamp is configured to adjust a position of the second contact pad relative to the user's forearm.

In some embodiments, the first clamp is configured to apply a first force to the user's forearm at the first location via the first contact pad, wherein the second clamp is configured to apply a second force to the user's forearm at the second location via the second contact pad. In some embodiments, the first rod is configured to change positions within the first adjustable slot, wherein the second rod is configured to change positions within the second adjustable slot. In some embodiments, changing the position of the first rod within the first adjustable slot adjust a first angle of the first contact pad relative to the base portion, wherein changing the position of the second rod within the second adjustable slot adjust a second angle of the second contact pad relative to the base portion. In some embodiments, the first end of the first clamp includes a first plurality of holes configured to receive the first rod and the first end of the second clamp includes a second plurality of holes configured to receive the second rod, wherein the first angle is adjusted by moving the first rod from a first hole of the first plurality of holes to a second hole of the first plurality of holes, wherein the second angle is adjusted by moving the second rod from a third hole of the second plurality of holes to a fourth hole of the second plurality of holes. In some embodiments, the base portion includes a first portion and a second portion, the first portion configured to be removable coupled to the second portion. In some embodiments, the medical device can further include: a first set of legs and a second set of legs, the first set of legs configured to be removably coupled to the bottom portion of the base portion at a first end, the second set of legs configure to be removably coupled to the bottom portion of the base portion at a second end, the second end opposite the first end. In some embodiments, the top portion includes a pad slot configured to receive a resting pad, the resting pad configured to be removably inserted into the pad slot. In some embodiments, a top surface of the resting pad is flat. In some embodiments, a top surface of the resting pad is convex. In some embodiments, a top surface of the resting pad is concave. In some embodiments, the first contact pad is configured to move between a first configuration and a second configuration with the second end of the first clamp, the first contact pad configured to rotate relative to the second end of the first clamp in the first configuration but not in the second configuration, wherein the second contact pad is configured to move between a first configuration and a second configuration with the second end of the second clamp, the second contact pad configured to rotate relative to the second end of the second clamp in the first configuration but not in the second configuration. In some embodiments, the first contact pad can move from the second configuration to the first configuration by applying a force perpendicular to a length of the first contact pad, wherein the second contact pad can move from the second configuration to the first configuration by applying a force perpendicular to a length of the second contact pad. In some embodiments, a first end of the second rod is configured to engage a first knob and a second end of the second rod is configured to engage a second knob. In some embodiments, the medical device can further include: a first set of a rails and a second set of rails, the first clamp configured to travel along the first set of rails, the second clamp configured to travel along the second set of rails, wherein adjusting a position of the first clamp on the first set of rails changes a height of the first contact pad relative to the base portion, wherein adjusting a position of the second clamp on the second set of rails changes a height of the second contact pad relative to the base portion.

### BRIEF DESCRIPTION OF THE DRAWINGS

Various embodiments are depicted in the accompanying drawings for illustrative purposes, and should in no way be interpreted as limiting the scope of the embodiments. Furthermore, various features of different disclosed embodiments can be combined to form additional embodiments, which are part of this disclosure.

FIG. 1 is a perspective view of an embodiment of a medical device.

FIG. 2A is a front view of the medical device shown in FIG. 1.

FIG. 2B is a side view of the medical device shown in FIG. 1.

FIG. 3A is a partial exploded view of a resting portion of the medical device of FIG. 1.

FIG. 3B is a perspective view of a central portion of the resting portion of the medical device of FIG. 1.

FIG. 3C is a perspective view of a side portion of the resting portion of the medical device of FIG. 1.

FIG. 4 is a perspective view of a contact assembly of the medical device of FIG. 1.

FIG. 5A is a perspective view of a contact portion of the contact assembly of FIG. 4.

FIG. 5B is a side view of the contact portion of the contact assembly of FIG. 4.

FIG. 6A is a first perspective view of a contact adaptor of the contact assembly of FIG. 4.

FIG. 6B is a second perspective view of the contact adaptor of the contact assembly of FIG. 4.

FIG. 7A is a partial exploded view of an actuator assembly of the medical device of FIG. 1.

FIG. 7B is a side view of the actuator assembly of FIG. 7A.

FIG. 8A is a perspective view of a receiver portion of the actuator assembly of FIG. 7A.

FIG. 8B is a bottom view of the receiver portion of FIG. 8A.

FIG. 8C is a perspective view of another embodiment of a receiver portion of the actuator assembly of FIG. 7A.

FIG. 8D is a front section view of the receiver portion of FIG. 8D.

FIG. 9A is a first perspective view of an angle adaptor of the actuator assembly of FIG. 7A.

FIG. 9B is a second perspective view of the angle adaptor of the FIG. 9B.

FIG. 9C is a perspective view of lock adaptor of the actuator assembly of FIG. 7A.

FIG. 10 is an example method of using the medical device of FIG. 1.

FIG. 11A is a side view of a user's arm positioned on the resting portion of the medical device of FIG. 1.

FIG. 11B is a side view of the user's arm positioned on the resting portion of the medical device of FIG. 1 with the contact portions rotated to rest on the surface of the user's skin.

FIG. 11C is a side view of the user's arm in a first position on the resting portion of the medical device of FIG. 1 with the contact portions in the second configuration.

FIG. 11D is a side view of the medical device of FIG. 1 illustrating moving the contact portions towards the first configuration.

FIG. 12 is a side view of the user's arm in a second position on the resting portion of the medical device of FIG. 1 with the contact portions in the second configuration.

FIG. 13 is a side view of the user's arm in a third position on the resting portion of the medical device of FIG. 1 with the contact portions in the second configuration.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

The present application relates to medical devices for treating forearm, wrist, or hand conditions, such as carpal tunnel, Guyon's canal, and/or DeQuervain's syndromes. The devices described herein are adapted to receive and support a user's arm (e.g., a user's forearm) and release myofascial restrictions by selectively applying forces at an angle relative to the user's arm at two location on the user's arm. The angular forces can cause the user's tissue to be compressed and stressed. For example, the medical devices can push into and spread the relevant wrist and forearm tissue with adjustable forces applied at an angle. The forearm can include any portion of the user's forearm from the elbow to the fingertips. These devices can be used under the supervision of a physical therapist, an occupational therapist, or a doctor or in the patient's home. For example, a patient or user may use the medical device to self-administer treatment, in some cases.

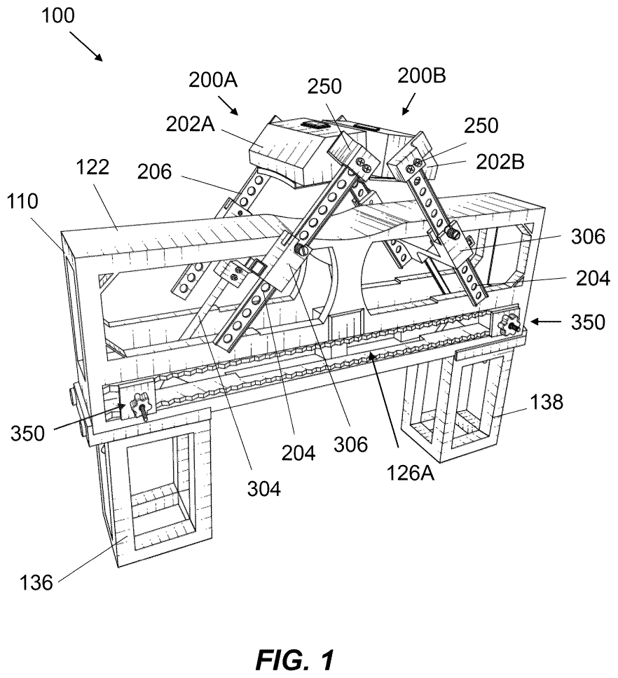

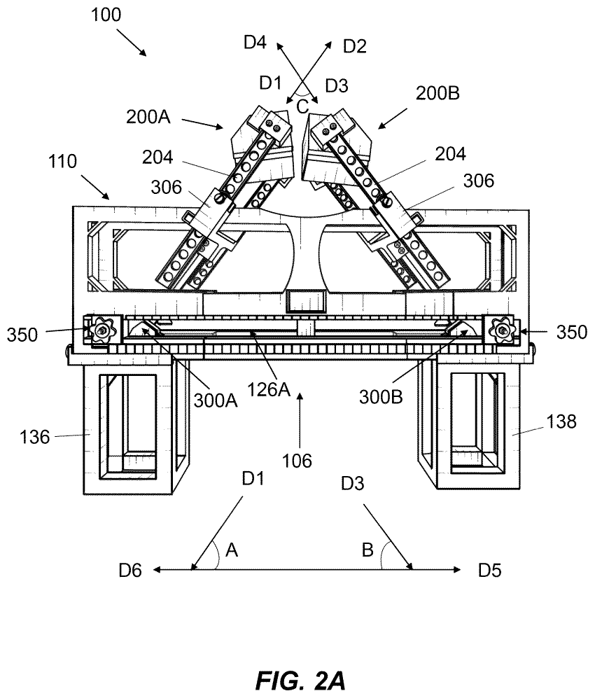

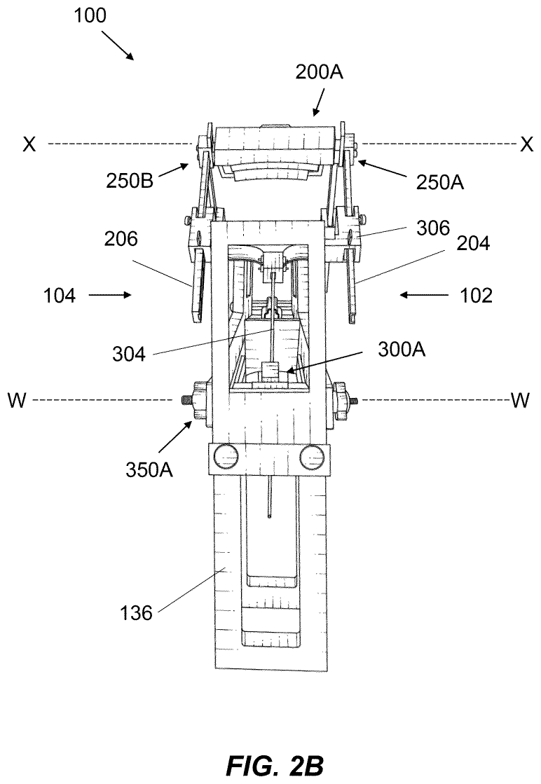

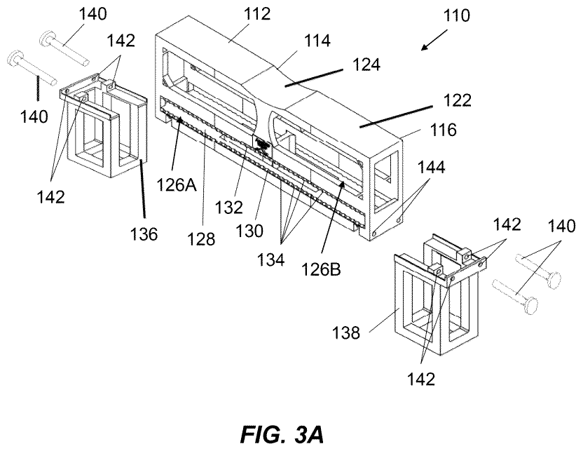

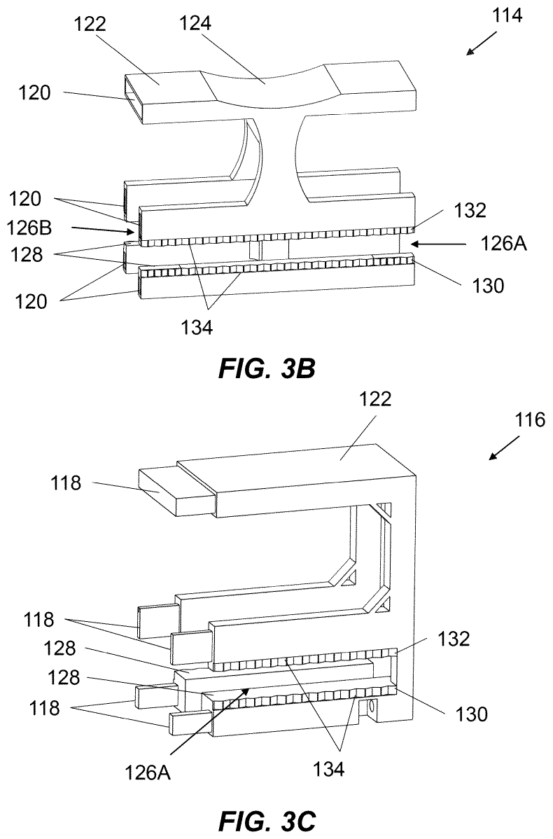

FIGS. 1 to 2B illustrate various views of a medical device 100 for treating forearm, wrist, or hand conditions, such as carpal tunnel, Guyon's canal, and/or DeQuervain's syndromes. FIGS. 3A to 9C illustrate various views of components that can be included in the medical device 100, in some embodiments.

The medical device can include a resting portion 110 for receiving and supporting a portion of a user's arm (e.g., a user's forearm), one or more contact assemblies 200 for contacting the user's arm opposite the resting portion 110, and/or one or more actuator assemblies 300 configured to move the contact assemblies 200 to apply forces to the user's arm (e.g., in an approximately posterior-anterior direction). The actuator assemblies 300 can apply forces to the user's arm via the contact assemblies 200 at an angle relative to the user's arm and/or relative to the resting portion 110. In some implementations, some, or all of the components of the medical device 100 can be made using additive manufacturing (e.g., three-dimensional printing). In some implementations, some, or all of the components of the medical device 100 can be manufactured by injection molding.

In the illustrated embodiment, the medical device 100 includes a first contact assembly 200A and a second contact assembly 200B (collectively referred to herein as “the contact assemblies 200”). The first contact assembly 200A can include a first contact portion 202A and the second contact assembly 200B can include a second contact portion 202B. The medical device 100 can include a first actuator assembly 300A and a second actuator assembly 300B (collectively referred to herein as “the actuator assemblies 300”). The first actuator assembly 300A can be coupled to the first contact assembly 200A and can be configured to move the first contact assembly 200A towards the resting portion 110 in a first direction D1 (see e.g., FIG. 2A) and/or away from the resting portion 110 in a second direction D2. The second direction D2 can be opposite the first direction D1. The first direction D1 can be at a first angle A relative to the resting portion 110. The first direction D1 can be adjusted by changing the first angle A, as described herein. Similarly, the second actuator assembly 300B can be coupled to the second contact assembly 200B and can be configured to move the second contact assembly 200B towards the resting portion 110 in a third direction D3 and/or away from the resting portion 110 in a fourth direction D4. The fourth direction D4 can be opposite the third direction D3. The third direction D3 can be at a second angle B relative to the resting portion 110. The third direction D3 can be adjusted by changing the second angle B as described herein. Generally, the first angle A is greater than 0 degrees and/or less than 90 degrees, and the second angle B is greater than 0 degrees and/or less than 90 degrees. Accordingly, the first angle A and the second angle B can be oblique or acute angles. An angle C between the first direction D1 and the third direction D3 can be obtuse (e.g., less than 180 degrees). In some cases, the angle C can be 90-degrees. In some cases, the angle C can be oblique. The first actuator assembly 300A can be used to independently control the movement of the first contact assembly 200A in the first direction D1 to apply a first force at the first angle A to the user's arm. For example, the first actuator assembly 300A can be configured to apply the first force at a first variable pull angle to the user's arm. The second actuator assembly 300B can be used to independently control the movement of the second contact assembly 200B in the third direction D3 to apply a second force at the second angle B to the user's arm. For example, the second actuator assembly 300B can be configured to apply the second force at a second variable pull angle to the user's arm.

The actuator assemblies 300 can be coupled to the resting portion 110 and can be moved relative to the resting portion 110. For example, the first actuator assembly 300A can be moved in a fifth direction D5 towards the second actuator assembly 300B and/or in a sixth direction D6 away from the second actuator assembly 300B. Similarly, the second actuator assembly 300B can be moved in the sixth direction D6 towards the first actuator assembly 300A and/or in the fifth direction D5 away from the first actuator assembly 300A. Moving the actuator assemblies 300 can change a distance between the first contact assembly 200A and the second contact assembly 200B. Changing the distance between the first contact assembly 200A and the second contact assembly 200B can change the locations of the forces applied to the user's arm by the contact assemblies 200. For example, the first contact assembly 200A can contact and apply a force in the first direction D1 at a first location and the second contact assembly 200B can contact and apply a force in the third direction D3 at a second location. The actuator assemblies 300 can be rotationally moveable (e.g., rotationally coupled) to the resting portion 110. For example, as shown in FIG. 2A, the first contact assembly 200A can be configured to rotate about an axis of rotation W. Rotating the actuator assemblies 300 relative to the resting portion 110 can change the angles A and B. As such, when the first actuator assembly 300A is rotated relative to the resting portion 110 to change the first angle A, the first direction D1 is also changed. Similarly, when the second actuator assembly 300B is rotated relative to the resting portion 110 to change the second angle B, the third direction D3 is also changed. The actuator assemblies 300 can be configured to move between a rotationally locked configuration, where the first angle A and the second angle B are set, and a rotationally unlocked configuration, where the first angle A and/or the second angle B can be changed.

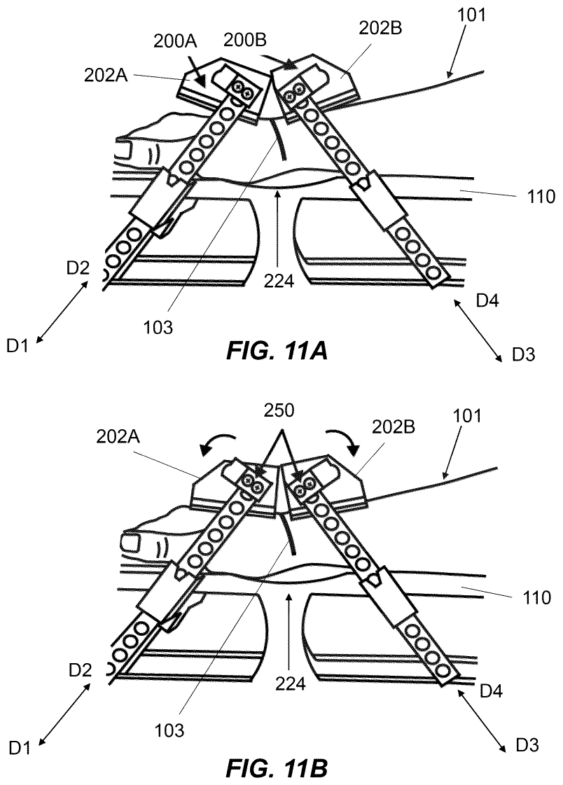

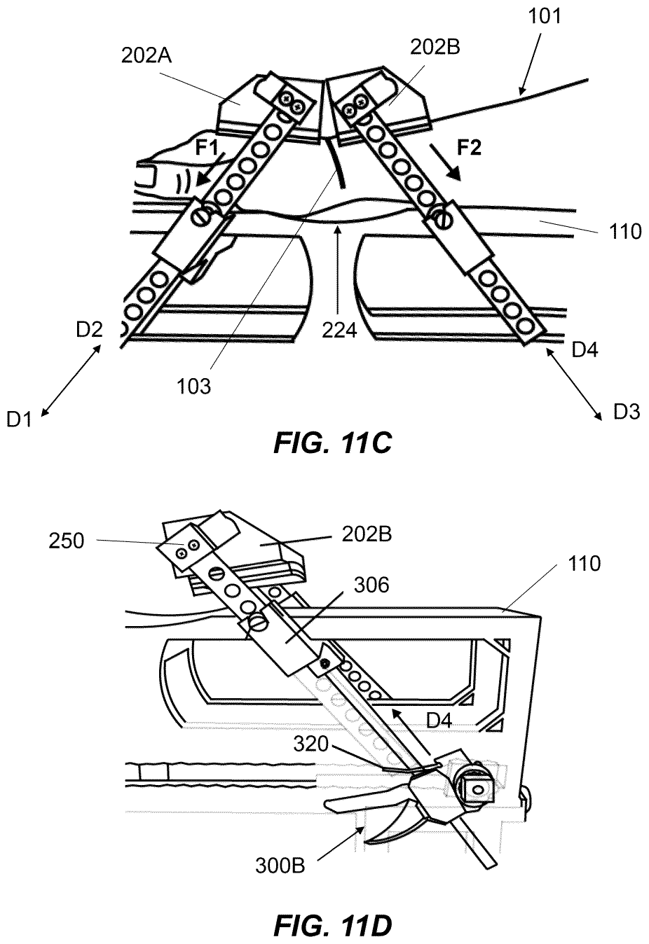

The contact assemblies 200 can be rotationally coupled to one or more actuator assemblies 300. For example, the first contact assembly 200A can be rotationally coupled to the first actuator assembly 300A and/or the second contact assembly 200B can be rotationally coupled to the second actuator assembly 300B. In some cases, it can be desirable for the first and second contact portions 202A, 202B to be substantially parallel to the resting portion 110 prior to use. In some cases, it can be desirable for the first and second contact portions 202A, 202B to be substantially parallel to the user's arm at the contact location. For example, the first contact portion 202A can lie flat (e.g., be substantially parallel) on the user's arm at the first location and the second contact portion 202B can lie flat (e.g., be substantially parallel) on the user's arm at the second location. In this arrangement, the first contact portion 202A may be at a different angle relative to the resting portion 110 than the second contact portion 202B. When the actuator assemblies 300 are moved or rotated relative to the resting portion 110, the first and second contact portions 202A, 202B can be angled relative to the resting portion 110 and/or the user's arm (see e.g., FIG. 11A). Accordingly, a user can rotate one or both of the first and second contact portions 202A, 202B relative to actuator assemblies 300 to realign the first and second contact portions 202A, 202B with the resting portion 110 and/or the user's arm (see e.g., FIG. 11B).

To use the medical device 100, the user can position their forearm between the resting portion 110 and the contact assemblies 200 (see e.g., FIG. 11B). In this arrangement, a first side of the user's forearm can be in contact with and supported by the resting portion 110. For example, in one use case an anterior side of the user's forearm can be supported by the resting portion 110. Prior to insertion of the user's forearm, the user can adjust the distance between the first contact assembly 200A and the second contact assembly 200B by moving the first actuator assembly 300A and/or the second actuator assembly 300B relative to the resting portion 110. The user can also adjust the first angle A by rotating the first actuator assembly 300A relative to the resting portion 110. The user can adjust the first angle B by rotating second actuator assembly 300B relative to the resting portion 110. The distance between the first contact assembly 200A and the second contact assembly 200B and the angles A, B can be set based on the desired treatment and the specific dimensions of the user's forearm. For example, user's with longer forearms may require a larger distance between the contact assemblies 200 than user's with shorter forearms. Additionally, the user can use the first actuator assembly 300A to move the first contact assembly 200A away from the resting portion 110 (e.g., in the second direction D2) and the second actuator assembly 300B to move the second contact assembly 200B away from the resting portion 110 (e.g., in the fourth direction D4) to provide a gap between the actuator assemblies 300 and the resting portion 110. The gap should be sufficiently large such that the user can insert their forearm between the contact assemblies 200 and the resting portion 110 with minimal or no contact between the contact assemblies 200 and the user's forearm. In this position, the actuator assemblies 300 are in a first configuration. In the first configuration there can be minimal or no contact between the contact assemblies 200 and the user's forearm. For example, minimal or no forces are applied to the user's forearm when the contact assemblies 200 are in the first configuration.

Once the user has set the desired distance between the contact assemblies 200 and the desired angles A, B, the user can position their forearm between the resting portion 110 and the contact assemblies 200, which can be in the first configuration. The user can then use the first actuator assembly 300A to move the first contact assembly 200A in the direction D1 towards the user's forearm. The user can move the first contact assembly 200A in the direction D1 until the first contact portion 202A contacts the user's arm at a first location. The user can continue to move the first contact assembly 200A to apply a first force at the first angle A at the first location on the user's forearm. In this position, the first contact assembly 200A is in a second configuration in which an angular force is being applied to the user's arm at the first location. Because the applied first force is at the angle A, the first force includes a first vertical force component (e.g., a compressive force) and a first horizontal force component (e.g., a stretching force). Accordingly, the first force applied by the first contact assembly 200A in the second configuration both compresses and stretches the user's tissue at the first location. Similarly, the user can use the second actuator assembly 300B to move the second contact assembly 200B in the direction D3 towards the user's forearm. The second contact assembly 200B can be moved independently of the first contact assembly 200A. The user can move the second contact assembly 200B in the direction D3 until the second contact portion 202B contacts the user's arm at a second location. The second location can be a set distance away from the first location. The user can continue to move the second contact assembly 200B to apply a second force at the second angle B at the second location on the user's forearm. In this position, the second contact assembly 200B is in a second configuration in which an angular force is being applied to the user's arm at the second location. Because the applied second force is at the angle B, the second force includes a second vertical force component (e.g., a compressive force) and a second horizontal force component (e.g., a stretching force). Accordingly, the second force applied by the second contact assembly 200B in the second configuration both compresses and stretches the user's tissue at the second location.

As the contact assemblies 200 are moved from the first configuration to the second configuration, the first contact assembly 200A and the second contact assembly 200B move away from each other, because of the angle C between the first direction D1 and the third direction D3, increasing the distance therebetween. When the first contact portion 202A and the second contact 202B are applying forces to the user's forearm at the first and second locations respectively, the first and second contact portions 202A, 202B stretch the tissue in the user's forearm, hand, and/or wrist. The user can use the first actuator assembly 300A to increase the first force applied at the first location and the second actuator assembly 300B to increase the second force applied at the second location. The first force and the second force can be independently controlled by the first actuator assembly 300A and the second actuator assembly 300B respectively. Accordingly, the first force can have a different magnitude than the second force. Increasing the applied first and/or second force can increase the stretch the user feels in their tissue. Increasing the applied first and/or second force can also increase the compressive force applied at the first and second locations.

Referring now to FIG. 3A, a partial exploded view of the resting portion 110 is illustrated. The resting portion 110 can be used to support the user's forearm during treatment. The user can position their forearm between the resting portion 110 and the contact assemblies 200 to stretch and compress the tissue in their forearm (e.g., when the contact assemblies 200 are moved into the second configuration). The resting portion 110 may also be referred to as the “base 110” herein. The resting portion 110 can include a first side portion 112, a center portion 114, and a second side portion 116. FIG. 3B shows an isolation view of the center portion 114 and FIG. 3C shows an isolation view of the second side portion 116. In some implementations, the first side portion 112 and the second side portion 116 may be removably coupled to the center portion 114. For example, the first side portion 112 and the second side portion 116 can be coupled to the center portion 114 for use of the medical device 100 and can be detached from the center portion 114 for storage. For example, as shown in FIG. 3C, the second side portion 116 can include one or more projections 118. The one or more projections 118 can be received within corresponding one or more slots 120 of the center portion 114, shown in FIG. 3B. The first side portion 112 can be similar or identical to the second side portion 116. In other implementations, the first and second side portion 112, 116 and the center portion 114 may be one individual component.

The resting portion 110 can include a top surface 122. The top surface 122 can extend along the tops of the first side portion 112, the center portion 114, and the second side portion 116. The top surface 122 can directly contact and support the user's forearm during use. The center portion 114 can include a stage 124. The stage 124 can be located in the center of the center portion 114. The stage 124 can be used for properly aligning the user's forearm during treatment. For example, in some cases, the user may align the soft tissue between the metacarpal bones and the radius and ulna bones with the center of the stage 124 prior to applying forces via the contact assemblies 200. In the illustrated example, the stage 124 has a concave or “U” shape. A concave stage 124 can be used to conform the user's wrist into a “U” shape, for example. In other implementations, the stage 124 can have a different shape. For example, the stage 124 can be flat, such that top surface 122 comprises a flat or planar surface extending from the first side portion 112 to the second side portion 116. In another example, the stage 124 can have a convex shape. In this example, the convex stage 124 can protrude away from the top surface 122. In some cases, when the stage 124 is flat or convex, the stage 124 may provide more support and comfort to the user during treatment compared to the convex stage. The shape of the stage 124 may be chosen for a particular treatment, based on a specific user's condition, and/or the like. In some implementations, the medical device 100 can include one or more removable inserts (not shown) that can be inserted into the stage 124. For example, the medical device 100 may include a flat and/or convex insert that can be placed or slid into the stage 124 to change the shape of the stage 124.

The resting portion 110 can include one or more slots 126. For example, the resting portion 110 can include a first slot 126A and a second slot 126B (collectively referred to herein as the slots 126). The slots 126 can be used to couple the actuator assemblies 300 to the resting portion 110. The actuator assemblies 300 can travel along the slots 126 to change the position of the actuator assemblies 300 relative to the resting portion 110 and to change the distance between the first contact assembly 200A and second contact assembly 200B. For example, the first actuator assembly 300A can travel along the slots 126 in the directions D5 and D6 and the second actuator assembly 300B can travel independently of the first actuator assembly 300A along the slots 126 in the directions D5 and D6. The slots 126 can extend between the first side portion 112 and the second side portion 116, and along the center portion 114. The first slot 126A can be on a front side 102 of the resting portion 110 and the second slot 126B can be on a back side 104 of the resting portion 110. The first slot 126A can be parallel to and aligned with the second slot 126B.

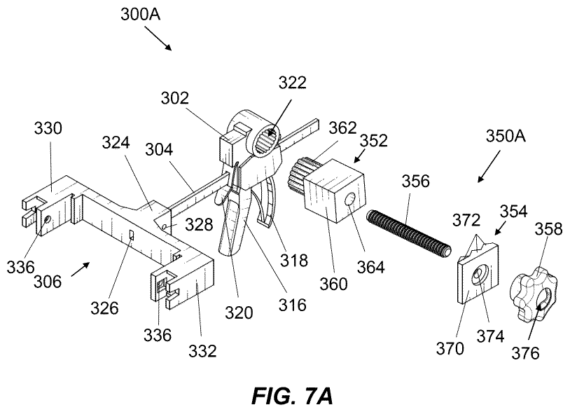

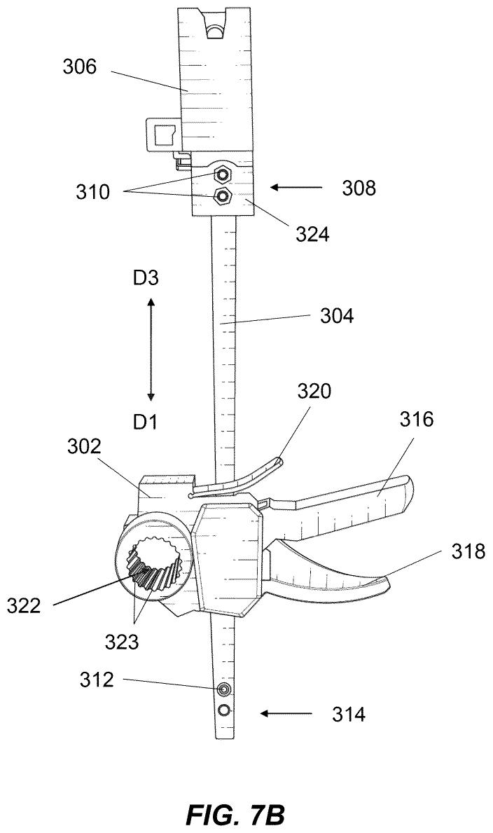

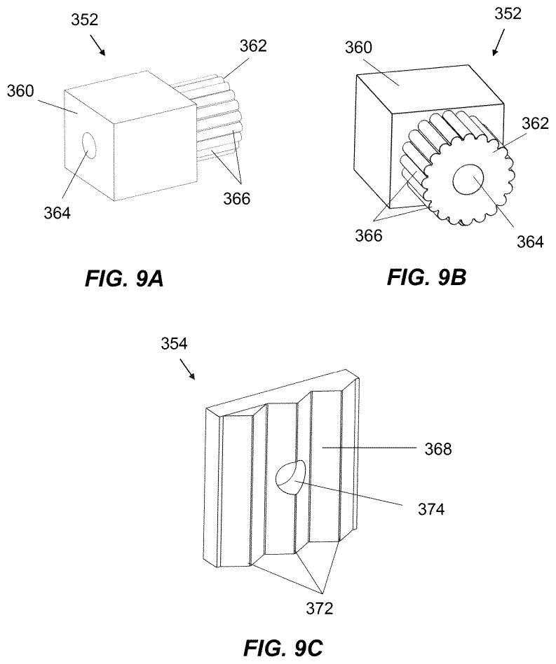

As shown in FIGS. 3A to 3C, the slots 126 can each include a sliding surface 128. The sliding surfaces 128 can form the bottom of the slots 126. The sliding surfaces 128 can be parallel to the flat portions of the top surface 122. In some implementations, each slot 126 can include a bottom teeth portion 130 and/or a top teeth portion 132. The bottom and top teeth portions 130, 132 can form the bottom and top of the slots 126 respectively. For example, the sliding surfaces 128 can be the top surfaces of the bottom teeth portions 130. Both the bottom and top teeth portions 130, 132 can include a plurality of teeth 134. The plurality of teeth 134 can be projections that extend substantially perpendicularly to the sliding surfaces 128. The bottom and top teeth portions 130, 132 can be used to lock the position of the actuator assemblies 300 along the slots 126. Engagement between the slots 126 and the actuator assemblies 300 is described further with reference to at least FIGS. 7A and 9C.

In some implementations, the slots 126 can be curved or angled relative to the top surface 122 of the resting portion 110. For example, the slots 126 can be closer to the top surface 122 near the first side portion 112 and the second side portion 116 and further from the top surface 122 at the center portion 114. Having curved slots 126 can allow the first angle A and the second angle B to change when the actuator assemblies 300 are translated along the slots 126, for example. In some implementations, the slots 126 can include ridges or fixed positions for the actuator assemblies 300.

Referring back to FIG. 3A, in some implementations, the resting portion 110 may include a first leg portion 136 and/or a second leg portion 138. The leg portions 136, 138 can be used to support the resting portion 110. For example, the medical device 100 may be used on a base surface, such as a table or the floor, and the leg portions 136, 138 may support the medical device 100. Including leg portions 136, 138 may provide a benefit of increasing the height of the top surface 122 relative to the base surface, which may allow the user to use the medical device 100 more comfortably. However, the leg portions 136, 138 are not required and the user can rest a bottom side 106 of the resting portion 110 on the base surface during use. In some implementations, the leg portions 136, 138 may be removable coupled to the first side portion 112 and the second side portion 116 respectively. For example, the resting portion 110 may include pins 140 for coupling the leg portions 136, 138 to the side portions 112, 116. For example, the leg portions 136, 138 may include one or more first holes 142 and the side portions 112, 116 may include one or more second holes 144 for receiving the pins 140. To couple the leg portions 136, 138 to the resting portion 110, the pins 140 can be inserted into the one or more first holes 142 and the one or more second holes 144. Other suitable mechanical means can also be used to connect the leg portions 136, 138 to the side portions 112, 116. Including detachable leg portions 136, 138 can provide a benefit of allowing the medical device 100 to be stored and/or transported in a compact manner.

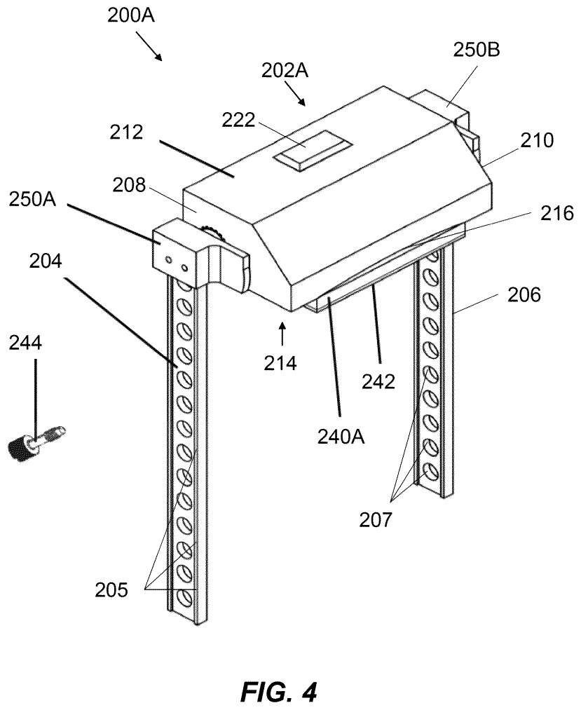

FIG. 4 shows a perspective view of the first contact assembly 200A coupled to a first connector rail 204 and a second connector 206. The first contact assembly 200A can be used to apply force to the user's arm. The first contact assembly 200A can apply a force at an angle (e.g., the first angle A) such that the first contact assembly 200A both compresses and stretches the user's tissue at the first location. The first contact assembly 200A can be coupled to the first actuator assembly 300A. The first actuator assembly 300A can be used to control the movement of the first actuator assembly 300A relative to the resting portion 110. The first actuator assembly 300A can be used to move the first contact assembly 200A in the first direction D1 (e.g., from the first configuration to the second configuration) to apply a first force to the user's arm. The first force can be applied at an angle relative to the resting portion 110. The first actuator assembly 300A can also be used to move the first contact assembly 200A away from the resting portion 110 in a second direction D2. The second direction D2 can be opposite the first direction D1. The first contact assembly 200A can be rotated relative to the first actuator assembly 300A. The first contact assembly 200A can be moved from a locked configuration, in which the first contact assembly 200A is rotationally fixed relative to the first actuator assembly 300A, and an unlocked configuration in which the first contact assembly 200A can rotate about an axis of rotation X (see e.g., FIG. 2B) relative to the first actuator assembly 300A. In some implementations, the first contact assembly 200A can include one or more buttons or actuators configured to move the first contact assembly 200A between the locked and unlocked configurations. In some cases, the user can move the first contact assembly 200A between the locked and unlocked configurations by actuating the one or more buttons with one hand. In some cases, the user can move the contact assembly 200A between the locked and unlocked configurations during use of the medical device 100. While not illustrated in isolation, the second contact assembly 200B can be identical to the first contact assembly 200A and can function in a similar or identical manner. However, the second contact assembly 200B can be independently controlled by the second actuator assembly 300B. The second actuator assembly 300B can be used to move the second contact assembly 200B in the third direction D3 and in an opposite fourth direction D4.

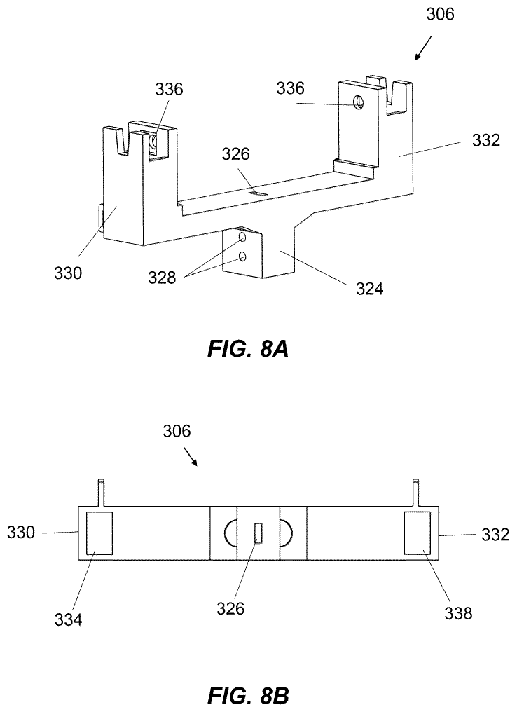

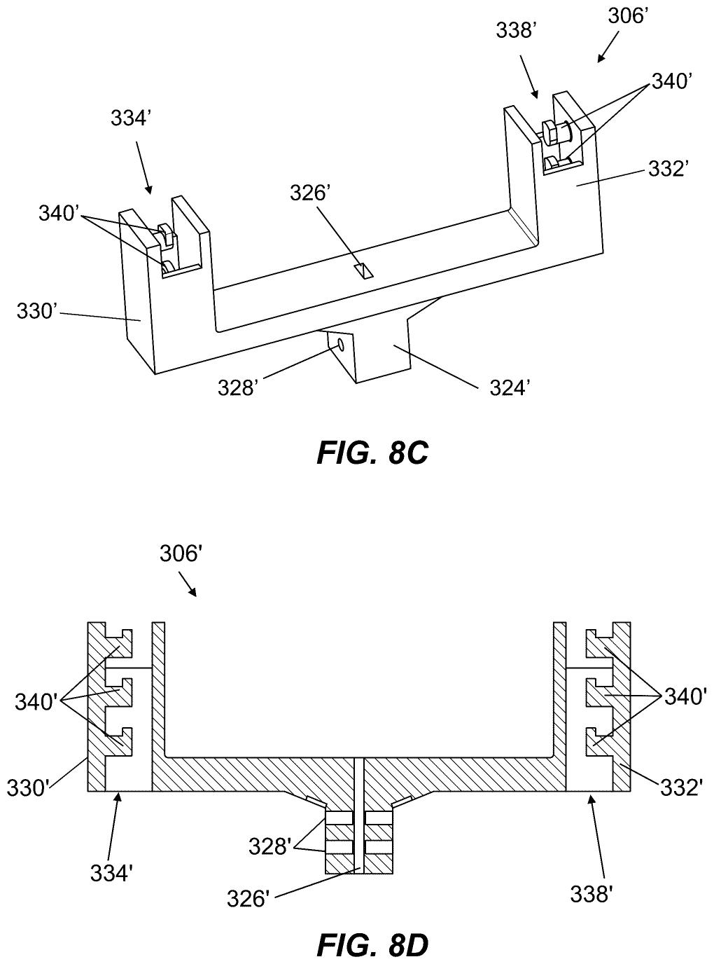

The first contact assembly 200A can include the first contact portion 202A and one or more contact adaptors 250. For example, the first contact assembly 200A can include a first contact adaptor 250A and a second contact adaptor 250B. The second contact adaptor 250B can be similar or identical to the first contact adaptor 250A and can function in the same manner as the first contact adaptor 250A. The first and second contact adaptors 250A, 250B can be used to connect the first contact portion 202A to the connector rails 204, 206. The connector rails 204, 206 can be coupled to the first actuator assembly 300A. For example, connector rails 204, 206 can be coupled to a receiver portion 306, 306′ (see e.g., FIGS. 8A and 8B) of the first actuator assembly 300A. The first and second contact adaptors 250A, 250B can be used to move the first contact portion 202A between the locked configuration and the unlocked configuration.

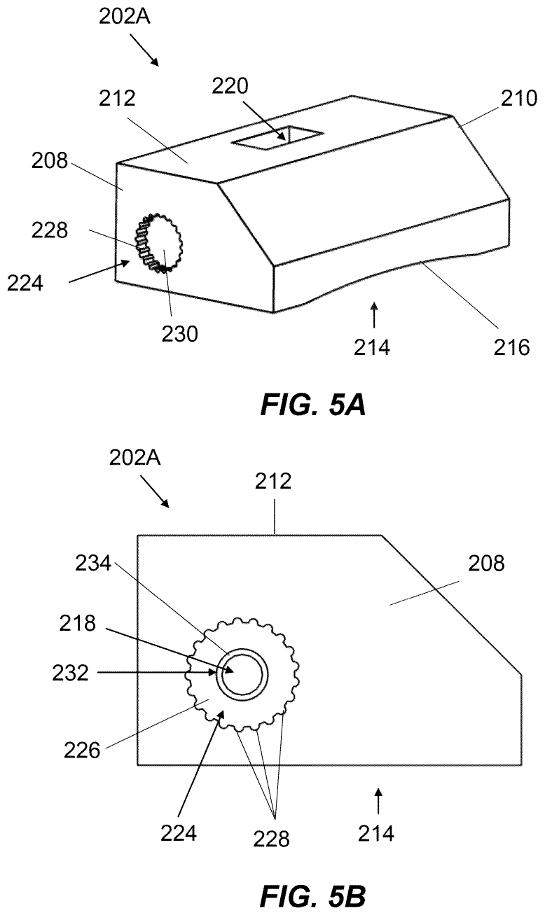

FIG. 5A shows a perspective view of the first contact portion 202A and FIG. 5B shows a side view of the first contact portion 202A. The first contact portion 202A can include a first side 208, a second side 210, a top side 212, and a bottom side 214. In some use cases, the bottom side 214 can directly contact the user's arm during use to apply the first force. As shown in FIG. 5A, the bottom side 214 can include a central arced portion 216. The central arced portion 216 can allow the first contact portion 202A to have a similar shape as the user's forearm, to increase user comfort during use. Including a central arced portion 216 can also increase the amount of contact (e.g., increased surface area) between the first contact portion 202A and the user's arm during use. Increased contact can provide a benefit of distributing the force over a larger portion of the user's arm. In other implementations, the bottom side 214 may be flat or convex, depending on the implementation and the desired treatment.

As shown in FIG. 5B, a first channel 218 can extend through the first contact portion 202A. The first channel 218 can extend from the first side 208 to the second side 210. The central axis of the first channel 218 can be the axis of rotation X. The first contact portion 202A can include an opening 220 in the top side 212. The opening 220 can allow access to the first channel 218. In some cases, the opening 220 can include a cover 222 (see e.g., FIG. 4). The first contact portion 202A can include a second channel 224. The second channel 224 can be axially aligned with the first channel 218. The second channel 224 can have a larger diameter than the first channel 218. The second channel 224 can extend from the first side 208 to a first inner wall 226. The first channel 218 can extend through the first inner wall 226. The first channel 218 and the second channel 224 can be configured to receive at least a portion of the first contact adaptor 250A. The second channel 224 can include a plurality of tooth spaces 228 that can extend into the body of the first contact portion 202A. As shown in FIG. 5A, the plurality of tooth spaces 228 can extend inwardly from the first side 208 towards the second side 210. The plurality of tooth spaces 228 may extend only partially into the second channel 224. An inner surface 230 of the second channel 224 may extend from the plurality of tooth spaces 228 towards the first inner wall 226. The inner surface 230 can be smooth. The first contact portion 202A can include a third channel 232. The third channel 232 can be axially aligned with the first channel 218 and the second channel 224. The third channel 232 can extend from the first inner wall 226 to a second inner wall 234. The third channel 232 can have a larger diameter than the first channel 218 and a small diameter than the second channel 224. The third channel 232 can be configured to receive a spring (not shown). The spring can be used with the first contact adaptor 250A to allow the first contact portion 202A to move between the locked configuration and the unlocked configuration, as described further herein. The spring can extend from the second inner wall 234 towards the first side 208. The first contact portion 202A can include a fourth channel (not shown) and a fifth channel (not shown) that extend inwardly from the second side 210. The fourth channel can be similar or identical to the second channel 224 and the fifth channel can be similar or identical to the third channel 232, expect on the second side 210. The first channel 218, the fourth channel, and the fifth channel can be configured to receive the second contact adaptor 250B.

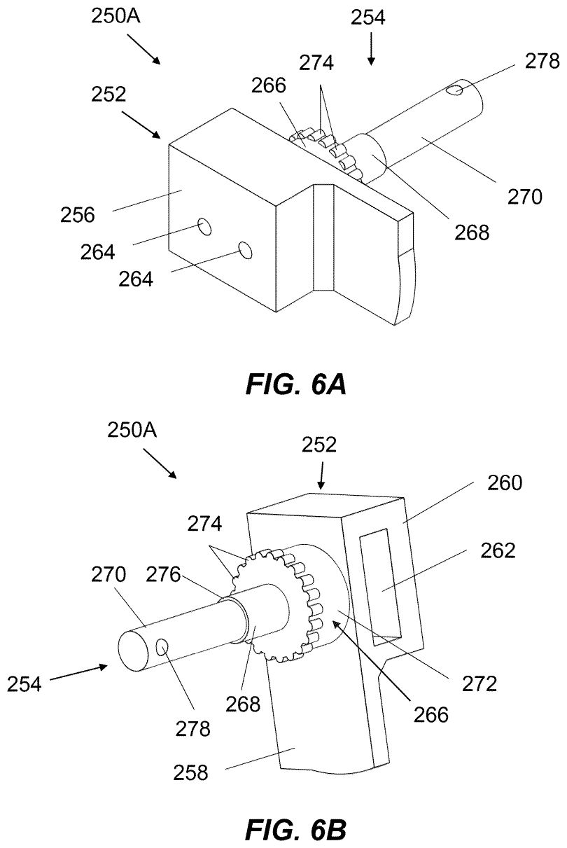

Referring now to FIGS. 6A and 6B, a first perspective view and second perspective view of the first contact adaptor 250A are shown. The first contact adaptor 250A can be used to connect the first contact assembly 200A to the first actuator assembly 300A via the first connector rail 204. The first contact adaptor 250A can also be used to move the first contact portion 202A between the locked and unlocked configurations. The first contact adaptor 250A can include a body 252 and a shaft assembly 254. The body 252 can include a first side 256, a second side 258, and a bottom side 260. As shown in FIG. 6B, the bottom side 260 can include an opening or slot 262. The slot 262 can be configured to receive the first connector rail 204. For example, as shown in FIG. 4, the first connector rail 204 can extend into the body 252 via the slot 262. The first connector rail 204 can be coupled to the body 252 via any conventional mechanical means. For example, the body 252 can include one or more fastener holes 264 in that can extend through the first side 256 and into the slot 262. The one or more fastener holes 264 can be configured to receive fasteners (not shown) to couple the first connector rail 204 to the body 252.

The shaft assembly 254 can extend from the second side 258 of the body 252. The second side 258 can face the first side 208 of the first contact portion 202A when the medical device 100 is assembled. The shaft assembly 254 can include a first shaft 266, a second shaft 268, and a third shaft 270. The first shaft 266 can be coupled to and extend from the second side 258. The first shaft 266 can include a smooth shaft portion 272 and a plurality of teeth 274. The plurality of tooth spaces 228 of the first contact portion 202A can be configured to receive the plurality of teeth 274 of the first contact adaptor 250A. The second shaft 268 can extend from the first shaft 266. The second shaft 268 can have a smaller diameter than the first shaft 266. The second shaft 268 can be received within the third channel 232 of the first contact portion 202A. The second shaft 268 can have a clearance fit with the third channel 232. The second shaft 268 can include a spring contact surface 276. When the shaft assembly 254 is inserted into the first contact portion 202A, the spring (not shown) can be compressed between the spring contact surface 276 and the second inner wall 234. The third shaft 270 can extend from the second shaft 268. The third shaft 270 can have a smaller diameter than the second shaft 268. The third shaft 270 can be received within the first channel 218 of the first contact portion 202A. The third shaft 270 can have a clearance fit with the first channel 218. The third shaft 270 can include a pin opening 278. The opening 278 can extend through the third shaft 270. The opening 278 can be perpendicular to a central axis of the third shaft 270. The second contact adaptor 250B can be similar or identical to the first contact adaptor 250A.

Referring back to FIG. 4, in the assembled first contact assembly 200A, the first contact adaptor 250A can be received within the first contact portion 202A. The first contact adaptor 250A can be configured to control the rotation of the first contact portion 202A about the axis of rotation X. For example, the first contact adaptor 250A can move the first contact portion 202A between the locked configuration and the unlocked configuration. In the assembled first contact assembly 200A, the third shaft 270 can be positioned in the first channel 218. To couple the first contact adaptor 250A to the first contact portion 202A, a pin (not shown) can be positioned in the opening 278 when the third shaft 270 is in the first channel 218. The pin can be inserted through the opening 220, for example. The pin can be sized to have a larger length than the diameter of the first channel 218. Accordingly, contact between the pin and an inner wall (not shown) of the first contact portion 202A that the first channel 218 extends through can prevent the first contact adaptor 250A from being removed from the first contact portion 202A. With the third shaft 270 within the first channel 218, the second shaft 268 can extend into the third channel 232 of the first contact portion 202A. The spring can be positioned between the second inner wall 234 and the spring contact surface 276. In this arrangement, the spring can be compressed, such that the spring biases the first contact adaptor 250A away from the second inner wall 234. Similarly, with the third shaft 270 within the first channel 218, the first shaft 266 can extend into the second channel 224 of the first contact portion 202A. When the first contact portion 202A is in the locked configuration, the plurality of teeth 274 of the first shaft 266 can be engaged with the plurality of tooth spaces 228 of the first contact portion 202A. In this arrangement, the first contact portion 202A is rotationally coupled to the first contact adaptor 250A. For example, engagement of the plurality of teeth 274 with the plurality of tooth spaces 228 can prevent rotation of the first contact portion 202A relative to the first contact adaptor 250A. To move the first contact portion 202A from the locked configuration to the unlocked configuration, the user can apply a force along the axis of rotation X to the first side 256 of the first contact adaptor 250A. For example, the user may press on the first side 256 to apply the force. When the force is applied, the plurality of teeth 274 can disengage from the plurality of tooth spaces 228 and can extend further into the second channel 224. In this position, the plurality of teeth 274 can be aligned with the inner surface 230 of the second channel 224. As such, the first contact portion 202A can be in the unlocked configuration and can freely rotate relative to the first contact adaptor 250A. Additionally, when the force is applied to the first side 256, the spring can be further compressed between the spring contact surface 276 and the second inner wall 234, increasing the spring force of the spring. To move the first contact portion 202A from the unlocked configuration to the locked configuration, the user can stop applying force to the first side 256. When the force is removed (e.g., when the user is no longer pressing on the first side 256), the spring force can cause the first contact adaptor 250A to move away from the third channel 232 along the axis of rotation X. When the spring pushes the first contact adaptor 250A away from the third channel 232, the plurality of teeth 274 can re-engage the plurality of tooth spaces 228, preventing further rotation of the first contact portion 202A relative to the first contact adaptor 250A. As such, the first side 256 of the body 252 of the first contact adaptor 250A can be used to move the first contact portion 202A between the locked and unlocked configuration. The first side 256 can function as a button or actuator to control the rotation of the first contact portion 202A about the axis of rotation X.

The second contact adaptor 250B can function in the same manner as the first contact adaptor 250A. The second contact adaptor 250B can extend into the first contact portion 202A through the second side 210 of the first contact portion 202A. The shaft assembly (not shown) of the second contact adaptor 250B can be received within the first channel 218, the fourth channel (not shown), and the fifth channel (not shown) or the first contact portion 202A. In some cases, the second contact adaptor 250B can be used to control the rotation of the first contact portion 202A about the axis of rotation X. For example, to move the first contact portion 202A from the locked configuration and the unlocked configuration, the user can apply a force to the first contact adaptor 250A along the axis of rotation X and in a direction towards the second contact adaptor 250B and the user can apply a force to the second contact adaptor 250B along the axis of rotation X and in a direction towards the first contact adaptor 250A. For example, the user may press on one of the contact adaptors 250A, 250B with their thumb and press on the other contact adaptor 250A, 250B with their finger. These pressing forces can compress the springs and cause the teeth (e.g., plurality of teeth 274) of the contact adaptors 250A, 250B to disengage from the tooth spaces (e.g., the plurality of tooth spaces 228) of the first contact portion 202A. With the pressing forces applied, the first contact portion 202A is in the unlocked configuration and can rotate about the axis of rotation X. To move the first contact portion 202A back to the locked configuration, the user can remove the pressing forces, which can cause the teeth of the contact adaptors 250A, 250B to re-engage the tooth spaces of the first contact portion 202A. As such, the contact adaptors 250A, 250B may act as actuators to control the rotation of the first contact portion 202A about the axis of rotation X.

With continued reference to FIG. 4, in some implementations, one or both of the contact assemblies 200 can include a contact pad 240. For example, the first contact assembly 200A can include a first contact pad 240A. The first contact pad 240A can be coupled to the bottom side 214 of the first contact portion 202A. The first contact pad 240A may extend over the central arced portion 216 and can conform to the shape of the central arced portion 216. In this arrangement, the first contact pad 240A may be positioned between the user's forearm and the first contact portion 202A during use. The contact pads 240 can comprise a compressible material, such as silicone. The contact pads 240 can increase the conform for the user when the first contact portion 202A is applying a force to the user's arm. In some implementations, the contact pad 240 may include an adhesive or an adhesive pad 242. For example, the adhesive pad 242 can be coupled to a bottom side of the contact pad 240. The adhesive pad 242 can promote or increase the traction between the user's skin and the first contact assembly 200A during use. For example, when the first contact assembly 200A is moved into the second configuration via the first actuator assembly 300A, the user's arm can be compressed at the first location between the first contact assembly 200A and the resting portion 110. The adhesive pad 242 can be in direct contact with the user's skin at the first location and can increase the traction and/or the stretching force applied by the first contact assembly 200A. For example, the adhesive pad 242 can prevent or reduce the chances of the first contact assembly 200A sliding along the user's arm during treatment.

Turning now to FIGS. 7A to 9C, various views of the first actuator assembly 300A and components thereof are illustrated. A partial exploded view of the first actuator assembly 300A is shown in FIG. 7A and a side view of the first actuator assembly 300A is shown in FIG. 7B. The first actuator assembly 300A can be used to control the movement of the first contact assembly 200A in the medical device 100. For example, the first actuator assembly 300A can be used to selectively move the first contact assembly 200A between the first configuration and the second configuration. For example, when the first contact assembly 200A is in the first configuration, the first actuator assembly 300A can be used to move the first contact assembly 200A in the first direction D1 (see e.g., FIG. 2A) towards the user's forearm that can be supported by the resting portion 110. The first actuator assembly 300A can be used to control the amount of force applied by the first contact assembly 200A when the first contact assembly 200A is in the second configuration and is applying the first force at the first location. After treatment is complete, the first actuator assembly 300A can also be used to release or move the first contact assembly 200A from the second configuration back to the first configuration in the direction D2 (see e.g., FIG. 2A).

The first actuator assembly 300A can be used to control the angle of the first force applied by the first contact assembly 200A. For example, the first actuator assembly 300A can be used to set the first angle A of the direction D1 relative to the resting portion 110. The first actuator assembly 300A can be rotationally coupled to the resting portion 110. For example, the first actuator assembly 300A can move from a rotationally locked configuration, in which the first angle A is set, and a rotationally unlocked configuration, in which the first angle A can be changed. Varying the first angle A can change the magnitudes of the first vertical force component (e.g., the compressive force applied by the first contact assembly 200A) and the first horizontal force component (e.g., the stretching force applied by the first contact assembly 200A) for the same applied first force. For example, when the first actuator assembly 300A is set to have a large first angle A (e.g., greater than 45 degrees), the first compressive force applied by the first contact assembly 200A can be larger than the first stretching force applied by the first contact assembly 200A. Conversely, when the first actuator assembly 300A is set to have a small first angle A (e.g., less than 45 degrees), the first stretching force applied by the first contact assembly 200A can be larger than the first compressive force applied by the first contact assembly 200A. The user can set the first angle A based on the desired or recommended treatment.

The first actuator assembly 300A can be used to control the distance between the first contact assembly 200A and the second contact assembly 200B. Changing the distance between the first contact assembly 200A and the second contact assembly 200B can also change the distance between the first location and the second location of the applied first and second forces. For example, the first actuator assembly 300A can be moveable relative to the resting portion 110. The first actuator assembly 300A can be moved between a linear locked configuration, in which the position of the first actuator assembly 300A relative to the resting portion 110 is set, and a linear unlocked configuration, in which the first actuator assembly 300A is moveable relative to the resting portion 110. In some cases, when the first actuator assembly 300A is in the linear unlocked configuration, the first actuator assembly 300A can translate along the resting portion 110 (e.g., in the direction D5 and/or the direction D6).

The second actuator assembly 300B can be similar or identical to the first actuator assembly 300A and can function in a similar or identical manner with respect to the second contact assembly 200B. For example, the second actuator assembly 300B can be used to independently control the movement of the second contact assembly 200B between the first configuration and the second configuration (e.g., in the third direction D3 and in the fourth direction D4). The second actuator assembly 300B can also be used to change the second angle B and to control the distance between the second contact assembly 200B and the first contact assembly 200A. Because the second actuator assembly 300B can control the second contact assembly 200B independently of the first actuator assembly 300A, the magnitude and direction of force applied by the second contact assembly 200B can be different than the magnitude and direction of the force applied by the first contact assembly 200A. Accordingly, the user can apply the first force at the first angle A at the first location and the second force at the second angle B at the second location, with the first force, first angle A, and first location being different that the second force, second angle B, and second location. In some cases, the actuator assemblies 300 can be pull mechanisms. In some cases, the actuator assemblies 300 can be clamp systems.

With continued reference to FIGS. 7A and 7B, the first actuator assembly 300A can include an actuator body 302, an actuator rail 304, a receiver portion, and/or a connector assembly 350A. FIGS. 8A and 8B show a first example of a receiver portion 306 and FIGS. 8C and 8D show a second example of a receiver portion 306′. Either the receiver portion 306 or the receiver portion 306′ can be included in the actuator assemblies 300. The components of the first actuator assembly 300A are not shown to scale for illustrative purposes. The actuator body 302 can be releasably coupled to the resting portion 110 via the connector assembly 350A. The actuator body 302 can be used to control the movement of the receiver portion 306, 306′ in the first direction D1 and the second direction D2 via the actuator rail 304. The first actuator assembly 300A can be coupled to the first contact assembly 200A by the receiver portion 306, 306′, as described with reference to at least FIGS. 8A and 8B. Accordingly, movement of the receiver portion 306, 306′ in the first and second directions D1, D2 causes corresponding movement of the first contact assembly 200A in the first and second directions D1, D2.

The actuator rail 304 can extend through the actuator body 302. The actuator rail 304 can be moveable relative to the actuator body 302 in the first and second directions D1, D2. The actuator body 302 can be used to control the movement of the actuator rail 304 via an internal control mechanism (not shown). For example, the actuator body 302 can include an internal sliding mechanism that can be used to cause the actuator rail 304 to translate in the first direction D1. The actuator rail 304 can also be moved in the second direction D2. For example, the actuator body 302 can be used to release the actuator rail 304 from the sliding mechanism. When the actuator rail 304 is released from the sliding mechanism, force applied in the second direction D2 (e.g., by the user) can cause the actuator rail 304 to move through the actuator body 302 in the second direction D2. The actuator rail 304 can be coupled to the receiver portion 306, 306′ near its first end 308. For example, one or more fasteners 310 can be used to couple the first end 308 of the actuator rail 304 to the receiver portion 306, 306′. Accordingly, movement of the actuator rail 304 in the second direction D2 can cause corresponding movement of the receiver portion 306, 306′ and the first contact assembly 200A in the second direction D2. In some implementations, the actuator rail 304 can be prevented from traveling completely through the actuator body 302 in the second direction D2. For example, the actuator rail 304 can include a lock pin 312 near its second end 314. When the lock pin 312 contacts the actuator body 302, further movement in the second direction D2 can be restricted.

The actuator body 302 can include a trigger 316, a handle 318, a release 320, and/or a connecting channel 322. The trigger 316 can be used to control the movement of the actuator rail 304 in the first direction D1. For example, the trigger 316 can be connected to the internal sliding mechanism of the actuator body 302. The user can move the trigger 316 towards the handle 318 to move the actuator rail 304 in the first direction D1. The trigger 316 can also be used to control the magnitude of the first force applied to the user's arm at the first location via the first contact assembly 200A. For example, when the first contact assembly 200A is in the second configuration, the trigger 316 can be actuated to increase the first force applied to the user via the first contact assembly 200A. In some cases, the user may hold the handle 318 and pull the trigger 316 toward the handle 318 with their hand to increase the force applied by the first contact assembly 200A. The release 320 can be used to release the actuator rail 304 from the sliding mechanism of the first actuator assembly 300A. For example, the user can engage the release 320 (e.g., by moving the release 320 towards the handle 318), which can cause the sliding mechanism to disengage from the actuator rail 304. With the release 320 engaged, the user can move the actuator rail 304 in the second direction D2. For example, the user may engage the release 320 to move the first contact assembly 200A from the second configuration back to the first configuration. The user may engage the release 320 to remove the force applied by the first contact assembly 200A after treatment is complete.

Turning now to FIGS. 8A and 8B, a perspective view and a bottom view of the receiver portion 306 are shown respectively. The receiver portion 306 can be used to couple the first actuator assembly 300A to the first contact assembly 200A. For example, the receiver portion 306 can be coupled first actuator assembly 300A via the actuator rail 304 and the receiver portion 306 can be coupled to the first contact assembly 200A via the connector rails 204, 206. The receiver portion 306 can include a bottom connector 324 for coupling the receiver portion 306 to the actuator rail 304. The bottom connector 324 can include a slot 326. The slot 326 can be configured to receive the first end 308 of the actuator rail 304. The bottom connector 324 can include one or more fastener holes 328. The one or more fastener holes 328 can extend through the bottom connector 324 and into the slot 326. The one or more fastener holes 328 can be configured to receive the one or more fasteners 310 to couple the actuator rail 304 to the receiver portion 306.

The receiver portion 306 can include a first rail connector 330 and/or a second rail connector 332. The first rail connector 330 can be configured to receive the first connector rail 204 and couple the first connector rail 204 to the receiver portion 306. The second rail connector 332 can be configured to receive the second connector rail 206 and couple the second connector rail 206 to the receiver portion 306. For example, as shown in FIG. 8B, the first rail connector 330 can include a first rail slot 334. The first rail slot 334 can extend through the first rail connector 330. The first rail connector 330 can also include a first fastener hole 336. The first fastener hole 336 can be threaded. As shown in FIG. 4, the first connector rail 204 can include a plurality of holes 205. To couple the first connector rail 204 to the first rail connector 330, the first connector rail 204 can be inserted into the first rail slot 334. Any of the holes 205 of the first connector rail 204 can then be aligned with the first fastener hole 336 of the first rail connector 330, and a fastener 244 (see e.g., FIG. 4) can be interested into the hole 205 and into the first fastener hole 336. Accordingly, the fastener 244 can prevent the first connector rail 204 for moving relative to the receiver portion 306 when inserted in the first fastener hole 336. In some implementations, the fastener 244 can be threaded and can threadedly engage the threads of the first fastener hole 336 for a secure coupling. The fastener 244 can be easily removed from the first fastener hole 336 to decouple the first connector rail 204 from the receiver portion 306. Similarly, as shown in FIG. 8B, the second rail connector 332 can include a second rail slot 338. The second rail slot 338 can extend through the second rail connector 332. The second rail connector 332 can also include a second fastener hole 336. The second fastener hole 336 can be threaded. As shown in FIG. 4, the connector rail 206 can include a plurality of holes 207. To couple the second connector rail 206 to the second rail connector 332, the second connector rail 206 can be inserted into the second rail slot 338. Any of the holes 207 of the second connector rail 206 can then be aligned with the second fastener hole 336 of the second rail connector 332, and a second fastener 244 can be interested into the hole 207 and into the second fastener hole 336. Accordingly, the second fastener 244 can prevent the second connector rail 206 from moving relative to the receiver portion 306 when inserted in the second fastener hole 336. In some implementations, the second fastener 244 can be threaded and can threadedly engage the threads of the second fastener hole 336 for a secure coupling. The second fastener 244 can be easily removed from the second fastener hole 336 to decouple the second connector rail 206 from the receiver portion 306. Because the connector rails 204, 206 include a plurality of holes (e.g., the plurality of holes 205, 207), the distance between the first contact assembly 200A and the first actuator assembly 300A can be selected based on the hole 205, 207, the fastener 244 is inserted in. This arrangement can provide a benefit of allowing the medical device 100 to be sized to the particular user.

Referring now to FIGS. 8C and 8D, another implementation of a receiver portion 306′ is shown. Either the receiver portion 306′ or the receiver portion 306 can be used in the actuator assemblies 300. Some features of the receiver portion 306′ are similar to features of the receiver portion 306 in at least FIGS. 8A and 8B. Thus, reference numerals used to designate the various features or components of the implantable receiver portion 306 are identical to those used for identifying the corresponding features of components of the receiver portion 306′ in FIGS. 8C and 8D, except that a “prime” has been added to the numerical identifier for the receiver portion 306′. Therefore, the structure and description for the various features of the receiver portion 306 and the operation thereof as described in at least FIGS. 8A and 8B are understood to also apply to the corresponding features of the receiver portion 306′ in FIGS. 8C and 8D, except as described differently below.

The receiver portion 306′ differs from the receiver portion 306 primarily in the manner in which the receiver portion 306′ attaches to the actuator rail 304. Like the receiver portion 306, the receiver portion 306′ can be used to couple the actuator assemblies 300 to contact assemblies 200. For example, the receiver portion 306′ can be coupled to the first actuator assembly 300A via the actuator rail 304 and the receiver portion 306′ can be coupled to the first contact assembly 200A via the connector rails 204, 206. However, the receiver portion 306′ may not include the fastener holes 336. Instead, both the first rail connector 330′ and second rail connector 332′ can include one or more projections 340′. The one or more projections 340′ of the first rail connector 330′ can extend inwardly into the first rail slot 334′ and the one or more projections 340′ of the second rail connector 332′ can extend inwardly into the second rail slot 338′. In the illustrated example, both the first rail connector 330′ and the second rail connector 332′ include three projections 340′. In other implementations, the rail connectors 330′, 332′ can include greater or fewer projections 340′.

As shown in FIG. 8D, the projections 340′ do not extend across the entire width of the rail slots 334′, 338′, such that a gap is provided between the inner wall of the rail slots 334′, 338′ and the projections 340′ for receiving the connectors rails 204, 206. The first rail connector 330′ can be configured to receive the first connector rail 204 and couple the first connector rail 204 to the receiver portion 306′. The second rail connector 332′ can be configured to receive the second connector rail 206 and couple the second connector rail 206 to the receiver portion 306′. As shown in FIG. 4, the first connector rail 204 can include a plurality of holes 205. To couple the first connector rail 204 to the first rail connector 330′, the first connector rail 204 can be inserted into the first rail slot 334′. Any of the holes 205 of the first connector rail 204 can then be aligned with the projections 340′ of the first rail connector 330′, and the projections 340′ can be inserted into the desired holes 205. The projections 340′ are spaced apart from each other with the same spacing as between the holes 205 of the connector rail 204. Accordingly, multiple projections 340′ can be inserted in multiple holes 205. When the projections 340′ are inserted in the holes 205 of the first connector rail 204, the projections 340′ can prevent the first connector rail 204 from moving relative to the receiver portion 306′. The projections 340′ can be hooked. For example, the projections 340′ can include lips or ridges at the end of the projections 340′ that restrict lateral movement of the connector rails 204, 206 once inserted in the holes 205. The second connector rail 206 can be coupled to the receiver portion 306′ via the second rail connector 332′ in a similar manner as the first rail connector 330′.

The projections 340′ of the rail connectors 330′, 332′ can allow the connector rails 204, 206 to be easily coupled and decoupled to the receiver portion 306′. Because the connector rails 204, 206 include a plurality of holes (e.g., the plurality of holes 205, 207), the distance between the first contact assembly 200A and the first actuator assembly 300A can be selected based on the holes 205, 207 the projections 340′ are inserted in. This arrangement can provide a benefit of allowing the medical device 100 to be sized to the particular user. To adjust the distance, the operator can move the first connector rail 204 and the second connector rails 206 inwardly towards each other, such that the projections 340′ disengage the holes 205, 207. For example, the user may apply a force to the contact adaptors 250A, 250B to cause the connectors rails 204, 206 to move inwardly towards each other, as described herein. Once the projections 340′ disengage the holes 205, 207, the first contact assembly 200A can be moved away from or towards the receiver portion 306′ to increase or decrease the distance between the first contact assembly 200A and the top surface 122. Once the desired distance is achieved, the projections 340′ can be inserted into the holes 205, 207 to lock the position. For example, the user can remove the force applied to the contact adaptors 250A, 250B, causing the connector rails 204, 206 to move away from each other. This configuration advantageously allows the user to adjust the distance of the first contact assembly 200A relative to the top surface 122 with one hand. For example, a user may be able to adjust the distance with one hand while the other arm positioned on the top surface 122. Being able to adjust the distance can also allow the user to release or remove the force applied by the contact assemblies after treatment. This arrangement also provides a benefit of providing a dual function for the contact adaptors 250A, 250B. For example, the contact adaptors 250A, 250B can adjust both the height of the contact assemblies 200 relative to the top surface 122 and the rotational position of the contact assemblies 200.

Referring back to FIG. 7A, the connector assembly 350A can be used to couple the first actuator assembly 300A to the resting portion 110. In some cases, the connector assembly 350A can be used to move the first actuator assembly 300A between the linear locked configuration and the linear unlocked configuration. In the linear unlocked configuration, the first actuator assembly 300A can move relative to the resting portion 110 in directions parallel to the first and second slots 126A, 126B. For example, in the linear unlocked configuration, the first actuator assembly 300A can move in the directions D5 and D6 shown in FIG. 2A. Conversely, in the linear locked configuration, a position of the first actuator assembly 300A relative to the resting portion 110 in the directions D5 and D6 can be fixed. In some cases, the connector assembly 350A can be used to move the first actuator assembly 300A between the rotationally locked configuration and the rotationally unlocked configuration. In the rotationally unlocked configuration, the first actuator assembly 300A can rotate about an axis of rotation W (see e.g., FIG. 2A) relative to the resting portion 110. Rotation of the first actuator assembly 300A about the axis of rotation W can change the first angle A and the first direction D1. When the first actuator assembly 300A is in the rotationally locked configuration, the first actuator assembly 300A cannot rotate about the axis of rotation W, and the first angle A and the first direction D1 can be fixed.

The connector assembly 350A can include one or more angle adaptors 352, one or more lock adaptors 354, a threaded rod 356, and/or one or more knobs 358. For example, the connector assembly 350A can include a first angle adaptor 352 and a second angle adaptor (not shown). The first angle adaptor 352 may also be referred to herein as a “slide adaptor”. The second angle adaptor can be similar or identical to the first angle adaptor 352. A first perspective view and a second perspective view of the first angle adaptor 352 are shown in FIGS. 9A and 9B respectively. The first angle adaptor 352 can include a sliding body 360 coupled to a shaft 362. A channel 364 can extend through both the sliding body 360 and the shaft 362. In the assembled medical device 100, a central axis of the channel 364 can define the axis of rotation W. The channel 364 can be configured to receive the threaded rod 356. The shaft 362 can be configured to be received within the connecting channel 322 of the actuator body 302 of the first actuator assembly 300A. The shaft 362 can include a plurality of teeth 366. The connecting channel 322 can include a plurality of teeth openings 323. The plurality of teeth 366 can be configured to engage the plurality of teeth openings 323 when the shaft 362 is inserted in the connecting channel 322. When the shaft 362 is inserted in the connecting channel 322, the first actuator assembly 300A can be coupled to and rotationally fixed to the first angle adaptor 352. When the shaft 362 is removed from the connecting channel 322, the first actuator assembly 300A can be rotated about the axis of rotation W.

The sliding body 360 can be configured to restrict vertical movement (e.g., in a direction perpendicular to the directions D5, D6). The sliding body 360 can be configured to allow the first actuator assembly 300A to be translated along the first slot 126A in the directions D5, D6. In the assembled medical device 100, the sliding body 360 can be inserted in the first slot 126A (see e.g., FIG. 2A). The sliding body 360 can have a clearance fit with the first slot 126A. Accordingly, the sliding body 360 can slide along the sliding surface 128 of the first slot 126A when the first actuator assembly 300A in the linear unlocked configuration. The sliding body 360 can be sized to restrict rotation of the first angle adaptor 352 relative to the first slot 126A. In the assembled medical device 100, the actuator body 302 can be positioned between the first slot 126A and the second slot 126B. In this position, the shaft 362 can be inserted in the connecting channel 322 and the sliding body 360 can be positioned in the first slot 126A and supported by the sliding surface 128. Similarly, the shaft 362 of the second angle adaptor can be inserted in the opposite side of the connecting channel 322 and the shaft 362 of the second angle adaptor can be positioned in the second slot 126B and support be sliding surface 128 of the second slot 126B. In this arrangement, the first actuator assembly 300A can be in the rotationally locked configuration and cannot rotate about the axis of rotation W. To change the first angle A, the angle adaptors 352 can be removed from the actuator body 302 and the first actuator assembly 300A can be rotated about the axis of rotation W. When the desired first angle A is selected, the angle adaptors 352 can be reinserted into the actuator body 302 and positioned within the slots 126A, 126B.

Referring back to FIG. 7A, the connector assembly 350A can include a first lock adaptor 354 and a second lock adaptor (not shown). The second lock adaptor can be similar or identical to the first lock adaptor 354. A perspective view of the lock adaptor 354 is shown in FIG. 9C. The connector assembly 350A can also include a first knob 358 and a second knob (not shown). The second knob can be similar or identical to the first knob 358. The first lock adaptor 354 can be configured to lock the first actuator assembly 300A in the linear locked configuration. In the linear locked configuration, the first actuator assembly 300A can be restricted from translating along the slots 126A, 126B in the directions D5, D6. The first lock adaptor 354 can include a first side 368 and a second side 370. An opening 374 can extend through the first lock adaptor 354 between the first and second sides 368, 370. The opening 374 can be configured to receive the threaded rod 356. The first side 368 can include one or more teeth 372. The one or more teeth 372 can be configured to engage the plurality of teeth 134 of the bottom and top teeth portions 130, 132 of the resting portion 110. The first knob 358 can include a threaded opening 376. The threaded opening 376 can be configured to threadedly engage the threads of the threaded rod 356.

In the assembled medical device 100, the threaded rod 356 can be inserted in the channel 364 of the first angle adaptor 352. The threaded rod 356 can be sized such that a portion of the threaded rod 356 extends out of both the first slot 126A and the second slot 126B when inserted in the channel 364 of the first angle adaptor 352. With the threaded rod 356 in position, the first lock adaptor 354 can be positioned on the threaded rod 356, with the threaded rod 356 extending through the opening 374 and the first side 368 facing first slot 126A. Similarly, the second lock adaptor can be positioned on an opposite side of the threaded rod 356 with the first side of the second lock adaptor facing the second slot 126B. In this arrangement, the first actuator assembly 300A can be in the linear unlocked configuration and can be translated along the slots 126A, 126B. To lock the position of the first actuator assembly 300A relative to the resting portion 110, the first knob 358 can be threaded on the threaded rod 356 via the threaded opening 376. As the first knob 358 is tightened on the threaded rod 356, the first knob 358 can force the plurality of teeth 366 of the first lock adaptor 354 to engage the plurality of teeth 134 of the bottom and top teeth portions 130, 132 of the resting portion 110. When the plurality of teeth 366 of the first lock adaptor 354 engage the plurality of teeth 134 of the resting portion 110, movement of the first actuator assembly 300A along the first slot 126A can be restricted. Similarly, on the opposite side of the resting portion 110, the second knob can be threaded on the threaded rod 356 via the threaded opening and can be tightened on the threaded rod 356 to force the plurality of teeth of the second lock adaptor to engage the plurality of teeth 134 of the bottom and top teeth portions 130, 132 near the second slot 126B. With the knobs 358 tightened on the threaded rod 356 and the teeth 366 of the lock adaptors 354 engaged with the plurality of teeth 134 of the resting portion 110, the first actuator assembly 300A can be in the linear locked configuration. To move the first actuator assembly 300A back to the linear unlocked configuration, the knobs 358 can be loosened so that the teeth 366 of the lock adaptors 354 disengaged from the plurality of teeth 134 of the resting portion 110. In this arrangement, the first actuator assembly 300A can freely translate along the slots 126A, 126B in the directions D5 and D6.

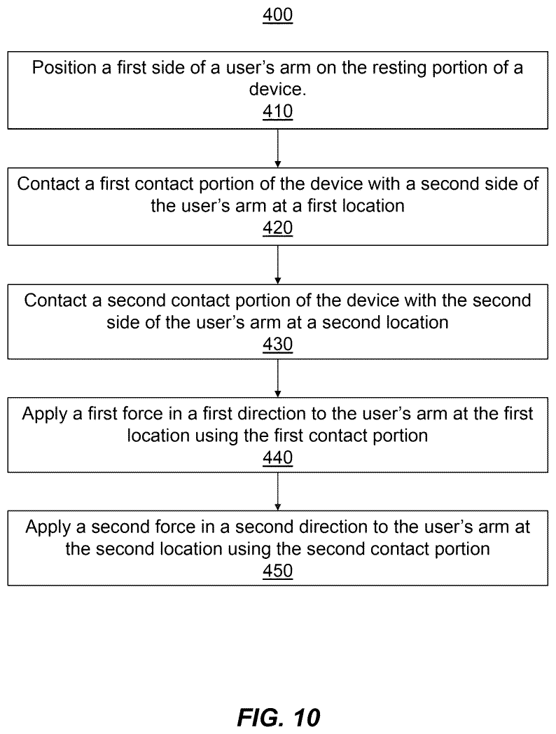

FIG. 10 illustrates an example method 400 of using the medical device 100 to treat a user. For example, the method 400 may be used to treat carpal tunnel syndrome, Guyon's canal syndrome, De Quervain's syndrome, and/or the like. It is recognized that there are other embodiments of the medical device 100 and the method 400 which may exclude some of the steps shown and/or may include additional steps not shown. Additionally, the steps discussed may be combined, separated into sub-steps, and/or rearranged to be completed in a different order and/or in parallel. The method 400 refers to FIGS. 11A to 13 for example. FIGS. 11A to 13 schematically illustrate a portion of the medical device 100 and an example user's arm 101.

Prior to beginning the method 400, the user may move the contact assemblies 200 to the first configuration such that a gap exists between the resting portion 110 and the contact assemblies 200. The user can move the contact assemblies 200 to the first configuration by actuating the releases 320 of the actuator assemblies 300, for example, The user may also set the desired first angle A and the desired second angle B via the actuator assemblies 300, as described herein. The user may also set a desired distance between the first contact assembly 200A and the second contact assembly 200B via the first actuator assembly 300A and/or the second actuator assembly 300B, as described herein.

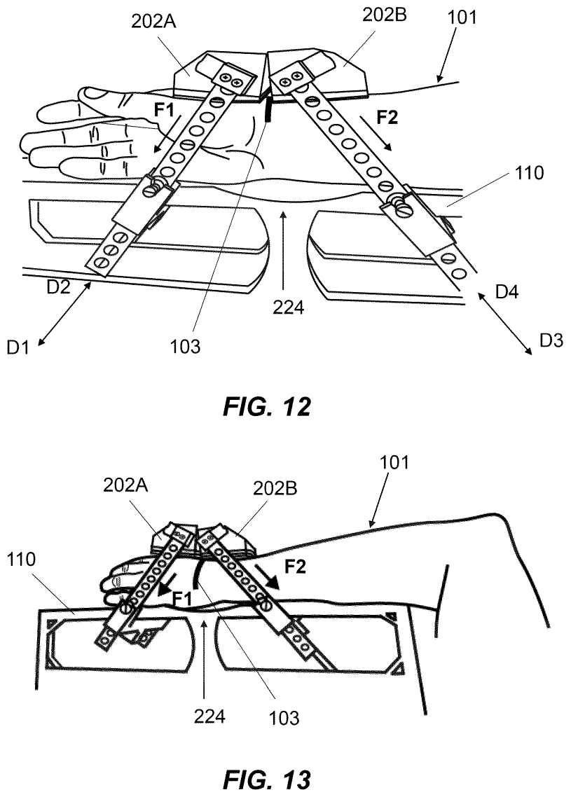

The method 400 begins at block 410, when the user positions a first side of their arm 101 on the resting portion 110 of the medical device 100. In one example, the first side of the user's arm 101 may be an anterior side of the user's forearm, as shown in FIG. 11A. In another example, the first side of the user's arm 101 may be medial or ulnar side of the user's forearm, as shown in FIG. 12. In yet another example, the first side of the user's arm 101 may be lateral or radial side of the user's forearm, as shown in FIG. 13. In other cases, the first side of the user's arm 101 may be the posterior side of the user's forearm. When the user positions their arm 101 on the resting portion 110, the resting portion 110 provides support for their arm 101.

In some cases, depending on the treatment, the user may draw a line 103 (e.g., with a marker) on the soft tissue of the user's wrist between the metacarpal bones and the radius and ulna bones. The user can align the line 103 with the center of the stage 124, as shown in FIG. 11A.

At block 420, the user can contact the first contact portion 202A with a second side of their arm 101 at a first location, as shown in FIG. 11A. For example, the user can move the first contact portion 202A in the first direction D1 via the first actuator assembly 300A. The first contact portion 202A may be moved from the first configuration in the direction D1. In one example, the second side of the user's arm 101 may be a posterior side of the user's forearm, as shown in FIG. 11A. In another example, the second side of the user's arm 101 may be lateral or radial side of the user's forearm, as shown in FIG. 12. In yet another example, the second side of the user's arm 101 may be the medial or ulnar side of the user's forearm, as shown in FIG. 13.

At block 430, the user can contact the second contact portion 202B with the second side of their arm 101 at the second location, as shown in FIG. 11A. For example, the user can move the second contact portion 202B in the third direction D3 via the second actuator assembly 300B. The second contact portion 202B may be moved from the first configuration in the direction D3.

Depending on the rotational position of the contact assemblies 200, the contact assemblies 200 may not be aligned with first and second locations on the user's arm 101. For example, as shown in FIG. 11A, the first contact assembly 200A and the second contact assembly 200B are not aligned with the user's arm 101. The user can use the contact adaptors 250 to move the first contact assembly 200A and/or the second contact assembly 200B into the rotationally unlocked configuration and rotate the first contact assembly 200A and/or the second contact assembly 200B until the first contact portion 202A and/or the second contact portion 202B are substantially parallel (e.g., flat) to the target locations (e.g., the first location and the second location) of the user's arm 101, as shown in FIG. 11B. In some cases, the user can rotate the first contact assembly 200A and/or the second contact assembly 200B with one hand while their arm 101 is positioned on the resting portion 110.

At block 440, the user can apply a first force F1 in the first direction D1 to their arm 101 at the first location using the first contact portion 202A, as shown in FIG. 11C. For example, the user can use the first actuator assembly 300A (e.g., the trigger 316) to move the first contact portion 202A towards the second configuration. In the second configuration, the first contact portion 202A can be applying the first force F1 in the first direction D1 to the first location of the user's arm 101. The user can continue to move the first contact portion 202A in the first direction D1 via the first actuator assembly 300A to increase the applied first force F1. Because the first force F1 is applied at the first angle A relative to the resting portion 110, the first force F1 can both stretch and compress the user's tissue at the first location. The first contact portion 202A can be moved to the second configuration independently of the second contact portion 202B. In some cases, depending on the treatment, the first location may be at, near, or above the metacarpal bones of the user's arm 101.

At block 450, the user can apply a second force F2 in the third direction D3 to their arm 101 at the second location using the second contact portion 202B, as shown in FIG. 11C. For example, the user can use the second actuator assembly 300B (e.g., the trigger 316) to move the second contact portion 202B towards the second configuration. In the second configuration, the second contact portion 202B can be applying the second force F2 in the third direction D3 to the second location of the user's arm 101. The user can continue to move the second contact portion 202B in the third direction D3 via the second actuator assembly 300B to increase the applied second force F2. Because the second force F2 is applied at the second angle B relative to the resting portion 110, the second force F2 can both stretch and compress the user's tissue at the second location. The second contact portion 202B can be moved to the second configuration independently of the first contact portion 202A. In some cases, depending on the treatment, the second location may be at, near, or above the radius and ulna bones of the user's arm 101.

With the first contact portion 202A and the second contact portion 202B in the second configuration, the user can use the first actuator assembly 300A and/or second actuator assembly 300B to increase or decrease the applied first force F1 and/or second force F2. In some cases, the user may preferably feel a strong but comfortable stretch in their arm 101 due to the applied first and second forces F1, F2. The user can continue to apply the stretch with the contact assemblies 200 in the second configuration for a set period of time. The period of time may be selected based on the desired treatment. In one example, the period of time may be between 1 and 15 minutes, between 2 and 10 minutes, between 3 and 5 minutes, and/or the like.

After the set period of time, the user can move the contact assemblies 200 from the second configuration to the first configuration to release the stretch, as shown in FIG. 11D. For example, the user can use the first actuator assembly 300A (e.g., the release 320) to move the first contact assembly 200A in the second direction D2 until the first force F1 is no longer applied at the first location. Similarly, the user can use the second actuator assembly 300B (e.g., the release 320) to move the second contact assembly 200B in the fourth direction D4 until the second force F2 is no longer applied at the second location. At this point, the user can remove their arm 101 from the resting portion 110.

FIG. 12 illustrates another example treatment arrangement with the user's arm in a second position. In the second position, the medial or ulnar side of the user's arm 101 can be supported by the resting portion 110. In the second position, the lateral or radial side of the user's arm 101 can be engaged by the contact assemblies 200. FIG. 13 illustrates another example treatment arrangement with the user's arm in a third position. In the third position, the lateral or radial side of the user's arm 101 can be supported by the resting portion 110. In the second position, the medial or ulnar side of the user's arm 101 can be engaged by the contact assemblies 200. In some cases, the medical device 100 may be positioned on a supporting surface with the front side 102 or the back side 104 in contact with the supporting surface. This arrangement may be used in the third position, for example, to increase the user's comfort during treatment.

### Additional Embodiments

While certain embodiments of the inventions have been described, these embodiments have been presented by way of example only and are not intended to limit the scope of the disclosure. Indeed, the novel methods, devices, and systems described herein may be embodied in a variety of other forms. Furthermore, various omissions, substitutions and changes in the systems, devices, and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. A device comprising:
a resting portion for receiving a first side of a user's arm;
a first contact portion configured to contact an opposite side of the user's arm at a first location; and
a second contact portion configured to contact the opposite side of the user's arm at a second location;
the device having a first configuration in which the first contact portion and the second contact portion apply no force or minimal force to the user's arm;
the device having a second configuration in which the first contact portion is moved away from the first configuration in a first direction to apply a first force at the first location to stretch and compress tissue in the user's arm and the second contact portion is moved away from the first configuration in a second direction to apply a second force at the second location to stretch and compress tissue in the user's arm.

2. (canceled)

3. (canceled)

4. The device of claim 1, wherein a first angle between the first direction and the resting portion is adjustable and a second angle between the second direction and the resting portion is adjustable.

5. (canceled)

6. The device of claim 1, wherein the first contact portion is configured to move independently of the second contact portion.

7-15. (canceled)

16. The device of claim 1, further comprising a first contact pad and a second contact pad, the first contact pad positioned between the first contact portion and the user's arm, the second contact pad positioned between the second contact portion and the user's arm.

17. (canceled)

18. The device of claim 16, wherein the first contact pad comprises a first contact surface including an adhesive and the second contact pad comprises a second contact surface including the adhesive, the adhesive configured to promote traction between the user's skin and the first contact pad and the second contact pad.

19. The device of claim 1, wherein the resting portion further comprises a top surface, the top surface configured to receive the first side of the user's arm, and wherein the top surface further comprises a convex central stage or a concave central stage.

20. (canceled)

21. (canceled)

22. (canceled)

23. The device of claim 1, wherein the first location is different than the second location.

24. The device of claim 32, where the first actuator is configured to translate along the base, wherein translation of the first actuator changes the first distance and the second distance.

25. The device of claim 32, where the second actuator is configured to translate along the base, wherein translation of the second actuator changes the first distance and the second distance.

26. A device comprising:
a base comprising:
a top portion for receiving a first side of a user's arm; and
a bottom portion for supporting the device;
a first contact portion configured to contact an opposite side of the user's arm;
a second contact portion configured to contact the opposite side of the user's arm;
a first actuator coupled to the base between the top portion and the bottom portion at a first end and coupled to the first contact portion at a second end;
a second actuator coupled to the base between the top portion and the bottom portion at a third end and coupled to the second contact portion at a third end;
the first actuator configured to move the first contact portion between a first configuration in which the first contact portion applies no force or minimal force to the user's arm and a second configuration in which the first contact portion applies a first force in a first direction to the user's arm at a first location;
the second actuator configured to move the second contact portion between a first configuration in which the second contact portion applies no force or minimal force to the user's arm and a second configuration in which the second contact portion applies a second force in a second direction to the user's arm at a second location.

27-31. (canceled)

32. The device of claim 26, wherein a first distance between the first contact portion and the second contact portion in the first configuration is adjustable, wherein adjusting the first distance changes a second distance between the first location and the second location.

33. The device of claim 26, wherein the first contact portion is rotatable relative to the first actuator and the second contact portion is rotatable relative to the second actuator.

34. The device of claim 26, wherein the first contact portion is configured to move between a locked configuration and an unlocked configuration, wherein in the unlocked configuration the first contact portion is rotatable relative to the first actuator, wherein in the locked configuration, the first contact portion is rotationally fixed to the first actuator.

35. (canceled)

36. The device of claim 26, wherein the first actuator is configured to adjust the first force in the first direction applied by the first contact portion and the second actuator is configured to adjust the second force in the second direction applied by the second contact portion.

37. The device of claim 36, wherein a first magnitude of the first force is independently controllable by the first actuator and a second magnitude of the second force is independently controllable by the second actuator.

38. The device of claim 26, wherein the first actuator further comprises a first release mechanism and the second actuator further comprises a second release mechanism, the first release mechanism configured to release a position of the first contact portion, the second release mechanism configured to release a position of the second contact portion.

39-46. (canceled)

47. A method for treating a user, the method comprising:
positioning a first side of a user's arm on a resting portion of a device;
contacting a first contact portion of the device with an opposite second side of the user's arm at a first location;
contacting a second contact portion of the device with the second side of the user's arm at a second location;
applying a first force in a first direction to the user's arm at the first location using the first contact portion to stretch and compress the user's arm at the first location; and
applying a second force in a second direction to the user's arm at the second location using the second contact portion to stretch and compress the user's arm at the second location.

48. (canceled)

49. The method of claim 47, further comprising at least one of:
adjusting a first angle of the first direction relative to the resting portion; or
adjusting a second angle of the second direction relative to the resting portion.

50. (canceled)

51. (canceled)

52. The method of claim 47, further comprising:
adjusting a distance between the first contact portion and the second contact portion.

53-66. (canceled)

67. The method of claim 47, further comprising:
rotating the first contact portion relative to the resting portion until the first contact portion lies flat on the first location.

68-70. (canceled)
